(19) United States
(12) Patent Application Publication
(10) Pub. No.: US 2006/0041443 A1
(43) Pub. Date: Feb. 23, 2006

(54) Variable data business system and method therefor

(76) Inventor: Charles W. Horvath JR., Las Vegas, NV (US)

Correspondence Address: WEISS & MOY PC, 4204 NORTH BROWN AVENUE, SCOTTSDALE, AZ, 85251, US

(21) Appl. No.: 10/923,767

(22) Filed: Aug. 23, 2004

(51) Int. Cl. G06Q 99/00

(52) U.S. Cl. 705/1

(57) ABSTRACT

A variable data business system and method provide improved production of documents in support of business operations. The system includes a server that stores business data and provides a network interface for access via a client browser. The system provides for entry, maintenance, and reporting functions of business data such mailing recipients, customer information, and business inventory. Interfaces are provided to access business data for the efficient design and production of personalized variable data documents. Themed promotional Internet websites are generated to complement themed promotional variable data document mailers. Automated electronic data gathering from third-party Internet information providers enhances the efficiency of business data collection and supports business transactions.

### FIELD OF THE INVENTION

This invention relates generally to business systems, and more particularly, to a business system using variable data print technology for marketing and operational support.

### DESCRIPTION OF THE RELATED ART

Frequently, businesses have a need to prepare printed materials in support of marketing efforts or business operations. It is well known that marketing materials are more effective when the materials are tailored to the recipients, such as targeting recipients that are likely to be interested in the product or service being marketed. Common techniques involve targeting recipients of a particular demographic class such as by race, sex, profession, or income. Additionally, it is well known that potential customers are more likely to purchase a product when sales calls, visits, or contacts with the seller are followed up with additional contacts, such as a follow-up letter or card. These follow-up materials are more effective still when personalized for the specific individual as opposed to general mass-produced materials. Another important factor in the effectiveness of follow-up materials is receipt of the materials in a timely manner, so that the recipient is more likely to still have interest in the marketed product.

Traditional print services for business support or marketing using a physical press are frequently unable to fulfill these needs in a cost-effective manner. Printing costs for each document tend to increase sharply when only a small number of documents are printed, and decrease only when large numbers, typically thousands or tens of thousands, of documents are ordered. The cost increase reflects the initial labor required by a printer to format and prepare a physical press for printing, a cost that tends to be independent of the number of documents ordered. Furthermore, as a practical consideration, the time required to complete such an order can typically take several days to weeks. This delay is caused by, among other factors, the time involved for financial approval of the purchaser's order by superiors or a purchasing department, acquisition of the artwork used in the documents, approval of the actual document design to match desired business standards, design and generation of a proof and approval of the proof, the availability of the printer's personnel and equipment, the printer's setup time for the print run, and the actual time required to run the printing equipment.

Variable data document production, in contrast, is a technology that allows a user to supply to a print server document formatting information and a supply of data that varies with each document for printing. Typically, the print server translates this data into instructions understood by a variable data digital press, which produces the documents. This technology provides the potential for a business to generate its own custom documents more quickly and in smaller quantities than a traditional print service. Prevalent uses of variable data document production for marketing and in support of business operations, however, under-utilize the full capability of the current technology. For example, documents such as flyers and post cards for marketing products or promotion are often generated where the only data that varies is the recipients' name and address in the portion of the document designated for a destination mailing address. Occasionally such documents feature a portion where the intended recipient's name is printed within the text of the document, to provide a more personalized message to the recipient.

Another major drawback is that a business generating its own documents must train and support a staff of capable graphic artists and computer personnel, incurring a significant drain on resources that may be otherwise focused on core business efforts. In addition, data collection and management required to support variable data printing is often duplicative of other efforts within the organization, and integrating a document production division within a business in an efficient manner can require a significant investment of time, money, and manpower.

A need therefore exists to provide a method of producing personalized documents in a timely yet cost-effective manner.

A need also exists to provide an efficient and cost-effective method of producing documents in small quantities in support of a business.

A need also exists to provide a method of producing documents in support of a business without introducing a significant drain on business resources.

A need also exists to provide a method of integrating the information and systems used for production of personalized documents with information and systems used in other business functions.

The present invention satisfies these needs, and provides other related advantages.

### SUMMARY OF THE INVENTION

The foregoing objectives are achieved in a variable data business system and method therefor.

In one embodiment of the present invention, a business method of using different and variable business data for various and separate business uses is disclosed. The method provides at least one collection of business data for one business use of the various and separate business uses, selects at least one business item from the collection of business data for the one business use; and prints with a variable data digital press multiple documents where each of the documents includes information corresponding to the at least one business item selected for the one business use.

Another embodiment of the present invention is a computer network system for supporting various business operations. The computer network system includes a variable data digital press system that includes a variable data digital press for generating variable data documents, and a server coupled via a network to the variable data digital press system. The server executes a program embodying a method that receives information for generating variable data documents, locates data in the server memory in conformity with the information that is received; transforms the received information and the located data for use by the variable data digital press system, and transmits the transformed information to the variable data digital press system to generate the variable data documents.

The foregoing and other objects, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a block diagram depicting network connections and computer systems in which embodiments of the invention may be practiced.

FIG. 2 is a flowchart depicting operation of a system as embodied in a method in accordance with an embodiment of the invention.

FIG. 3A is a block diagram depicting collections of business data in accordance with an embodiment of the present invention.

FIG. 3B is a block diagram depicting a selection of business data from the collections of business data of FIG. 3A in accordance with an embodiment of the present invention.

FIG. 3C is a block diagram depicting a generation of input files from the data selected in FIG. 3B in accordance with an embodiment of the present invention.

FIG. 3D is a block diagram depicting the generation of variable data documents from the input files of FIG. 3C in accordance with an embodiment of the present invention.

FIG. 4A is a block diagram depicting operation of a system in response to a new item of inventory in accordance with an embodiment of the present invention.

FIG. 4B is a block diagram depicting operation of a system in response to removal of an item of inventory in accordance with an embodiment of the present invention.

FIG. 4C is a block diagram depicting operation of a system in response to removal of an item of inventory in accordance with an embodiment of the present invention.

FIG. 5A is a block diagram depicting information corresponding to an item of inventory stored in a collection of business data in accordance with an embodiment of the present invention.

FIG. 5B is a block diagram depicting information corresponding to a variable data document template stored in a collection of business data in accordance with an embodiment of the present invention.

FIG. 5C is a block diagram depicting information corresponding to mailing recipients stored in a collection of business data in accordance with an embodiment of the present invention.

FIG. 5D is a block diagram depicting components of a system for generating variable data documents using the collections of business data of FIGS. 5A, 5B, and 5C in accordance with an embodiment of the present invention.

FIG. 6 is a pictorial diagram depicting a themed website and variable data document template in accordance with an embodiment of the present invention.

FIG. 7 is a block diagram depicting components of a system for performing a data redundancy check in accordance with an embodiment of the present invention.

FIG. 8 is a block diagram depicting components of a system for generating variable data personalized customer lead documents in accordance with an embodiment of the present invention.

FIG. 8A is a block diagram depicting operation of a system generating variable data personalized customer follow-up documents in accordance with an embodiment of the present invention.

FIG. 8B is a block diagram depicting components of a system for generating variable data personalized referral documents in accordance with an embodiment of the present invention.

FIG. 9 is a pictorial diagram depicting a marketing website and variable data document template in accordance with an embodiment of the present invention.

FIG. 10 is a block diagram depicting a computer network system for supporting business operations in accordance with an embodiment of the present invention.

FIG. 11 is a block diagram depicting a portable device and camera in accordance with an embodiment of the present invention.

FIG. 12 is a block diagram depicting components of a computer network system for supporting business operations in accordance with an embodiment of the present invention.

FIG. 13 is a block diagram depicting organization of computer programs and data within the memories of the computer system depicted in FIG. 12.

FIG. 14A is a flowchart depicting operation of a system generating variable data documents in accordance with an embodiment of the present invention.

FIG. 14B is a flowchart depicting operation of a system generating variable data documents following the operation depicted in FIG. 14A in accordance with an embodiment of the present invention.

FIG. 14C is a flowchart depicting operation of a system generating variable data documents following the operation depicted in FIG. 14B in accordance with an embodiment of the present invention.

FIG. 15 is a flowchart depicting operation of a system obtaining Internet provider information in accordance with an embodiment of the present invention.

FIG. 16 is a pictorial diagram depicting a user interface of a client computer for selecting a variable data document template in accordance with an embodiment of the present invention.

FIG. 17 is a pictorial diagram depicting a user interface of a client computer for selecting variable data document recipient parameters in accordance with an embodiment of the present invention.

FIG. 18 is a pictorial diagram depicting a user interface of a client computer for populating variable data regions of a document template in accordance with an embodiment of the present invention.

FIG. 19 is a pictorial diagram depicting a user interface of a client computer presenting a document template with populated variable data regions in accordance with an embodiment of the present invention.

FIG. 20 is a pictorial diagram depicting a user interface of a client computer presenting inventory items for selection to populate variable data fields of a document template in accordance with an embodiment of the present invention.

FIG. 21 is a pictorial diagram depicting a user interface of a client computer for inventory management in accordance with an embodiment of the present invention.

FIG. 22 is a pictorial diagram depicting a user interface of a client computer for performing an inventory search in accordance with an embodiment of the present invention.

FIG. 23 is a pictorial diagram depicting a user interface of a client computer for detailed inventory item information management in accordance with an embodiment of the present invention.

FIG. 24 is a pictorial diagram depicting a user interface for a marketing website in accordance with an embodiment of the present invention.

FIG. 25 is a pictorial diagram depicting a user interface for a marketing website in accordance with an embodiment of the present invention.

FIG. 26 is a pictorial diagram depicting a user interface of a client computer for monthly scheduling in accordance with an embodiment of the present invention.

FIG. 27 is a pictorial diagram depicting a user interface of a client computer for daily scheduling in accordance with an embodiment of the present invention.

FIG. 28 is a pictorial diagram depicting a user interface of a client computer for upcard data entry in accordance is with an embodiment of the present invention.

FIG. 29 is a pictorial diagram depicting a user interface of a client computer for lead management in accordance with an embodiment of the present invention.

FIG. 30 is a pictorial diagram depicting a user interface of a client computer for transaction support in accordance with an embodiment of the present invention.

FIG. 31 is a pictorial diagram depicting a user interface of a client computer for transaction support in accordance with an embodiment of the present invention.

FIG. 32 is a pictorial diagram depicting a user interface of a client computer for image association in accordance with an embodiment of the present invention.

### DESCRIPTION OF EMBODIMENTS OF THE INVENTION

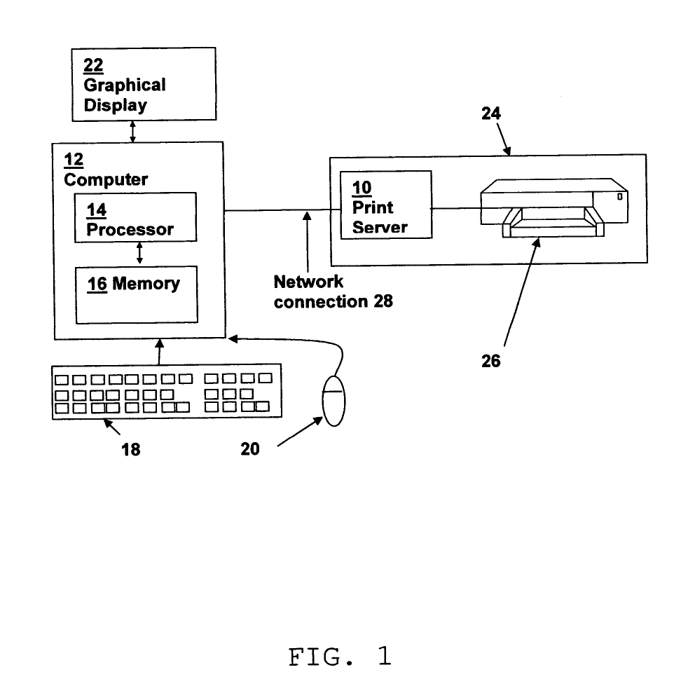

With reference now to the figures, and in particular to FIG. 1, block diagram of a system for generating variable data documents to support methods of the present invention is shown. A computer 12 having a memory 16 for storing data and program instructions and a processor 14 for executing the program instructions is coupled via a network connection 28 to a variable data digital press system 24. The variable data digital press system comprises a print server 10 and a variable data digital press 26.

General Method

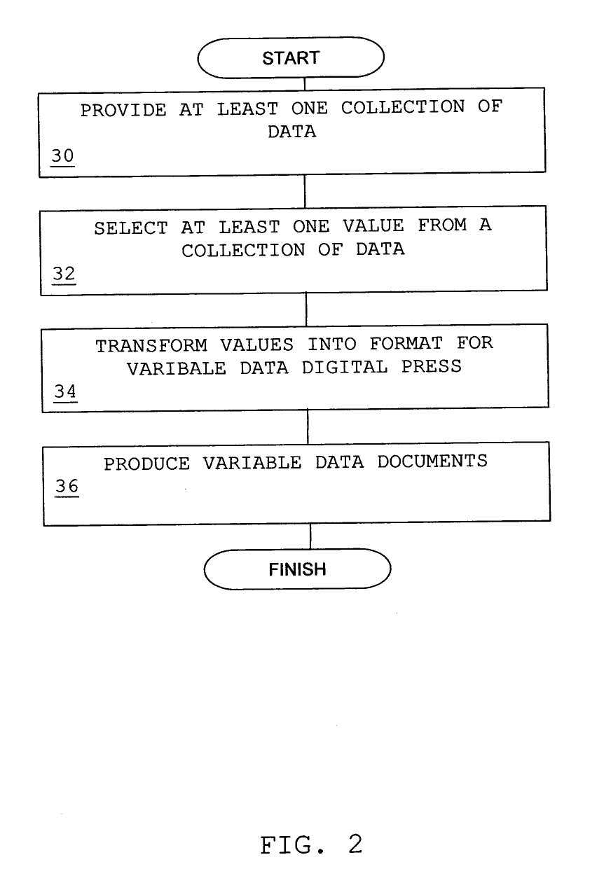

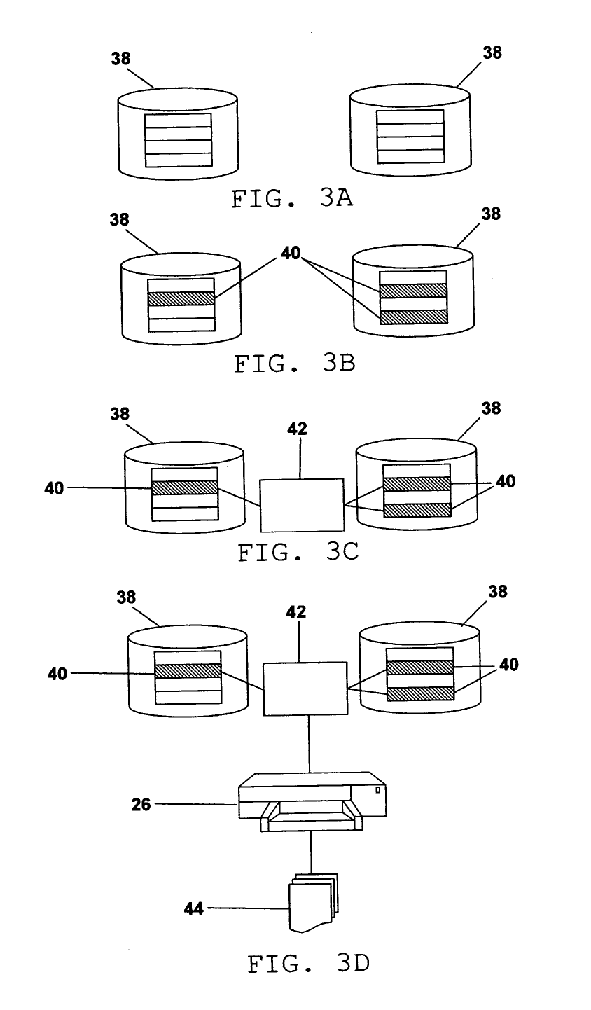

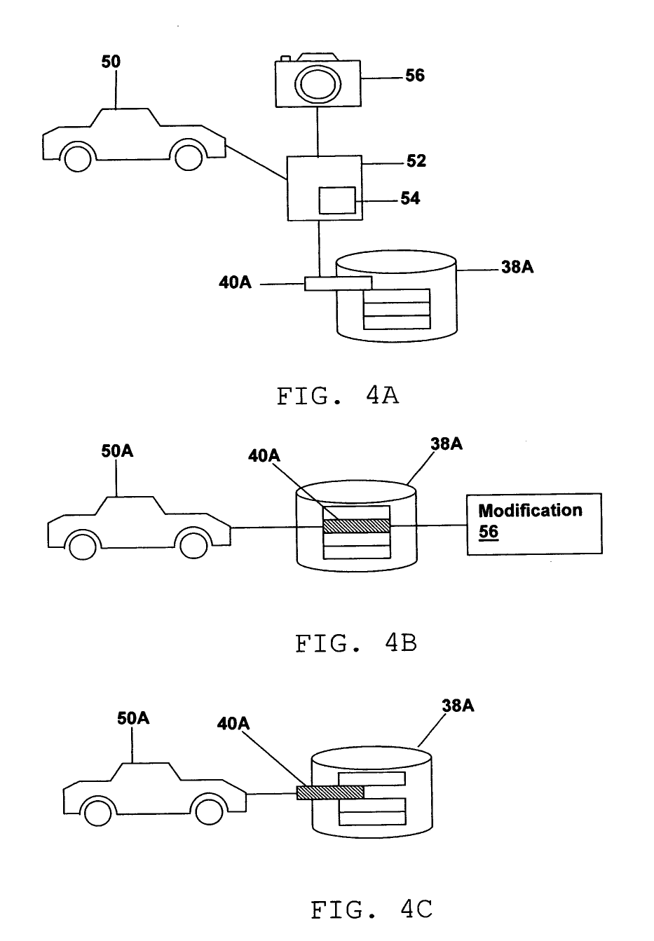

In accordance with an embodiment of the present invention, a business method of using different and variable business data for various and separate business uses is depicted in FIGS. 2, 3A, 3B, 3C, and 3D. It includes the steps of providing at least one collection of business data 38 (step 30) for one business use of the various and separate business uses, selecting at least one business item 40 from the at least one collection of business data 38 (step 32) for the one business use; and printing with a variable data digital press 26 multiple documents 44 wherein each of the documents comprising information corresponding to the at least one business item 40 (step 36) selected for the one business use. As used herein, “print” and “printing” refer to the generation of documents by the variable data digital press 26.

As shown in FIG. 3A, the collections of business data 38 may be databases existing in electronic memory 16 of a computer 12 (FIG. 1). Each collection of business data 28 may correspond to a specific type of data, such as personal information, inventory information, and formatting information for production of documents. The databases 38 are preferably indexed, searchable, and provide data selection and retrieval. Although the collections of business data 38 are preferably separate databases for each category of data, it should be clearly understood that significant benefits may be obtained by having the collections of business data 38 within a single database, or having multiple databases for each collection of business data.

FIG. 3C depicts a transformation of data that is preferably preformed by an algorithm executed by a processor 14. The algorithm receives the selected business items 40 and generates one or more input files 42 containing information corresponding to the selected business items 40 in a format acceptable to a variable data digital press 26 for printing. Additional information required by the variable data digital press 26 may also be included in the input files 42 such as paper size and formatting information. The input files 42 are preferably provided to the variable data digital press 26 via a network connection 28, although other methods of data transfer may be used, for example: storing the input files on physical media, transferring the physical media to an input device for the variable data digital press, and retrieval of the input files by input device for the variable data digital press from the physical media.

It should be understood that generation of input files 42 may not be necessary for a variable data digital press 26 if the variable data digital press 26 is capable of directly receiving data for print via electronic transmission, such as sequentially providing each value needed for printing a single document 44 in response to the completion of printing a previous document 44. A transformation of data (step 34) may then be accomplished by preparing the data for each document 44 from the selected business items 40 for electronic transmission and transmitting the information in a format acceptable by the variable data digital press 26.

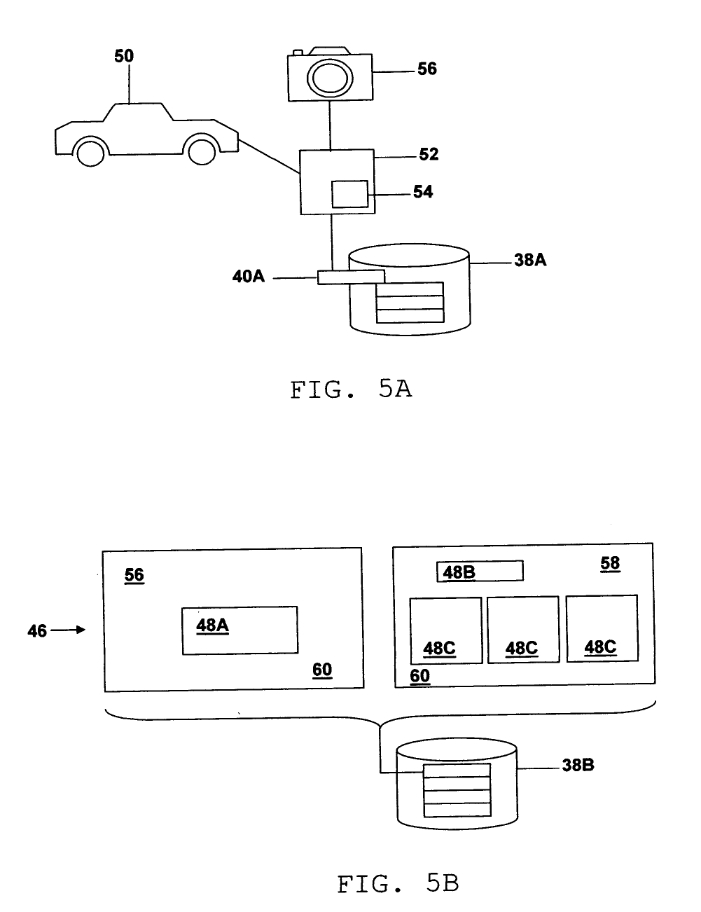

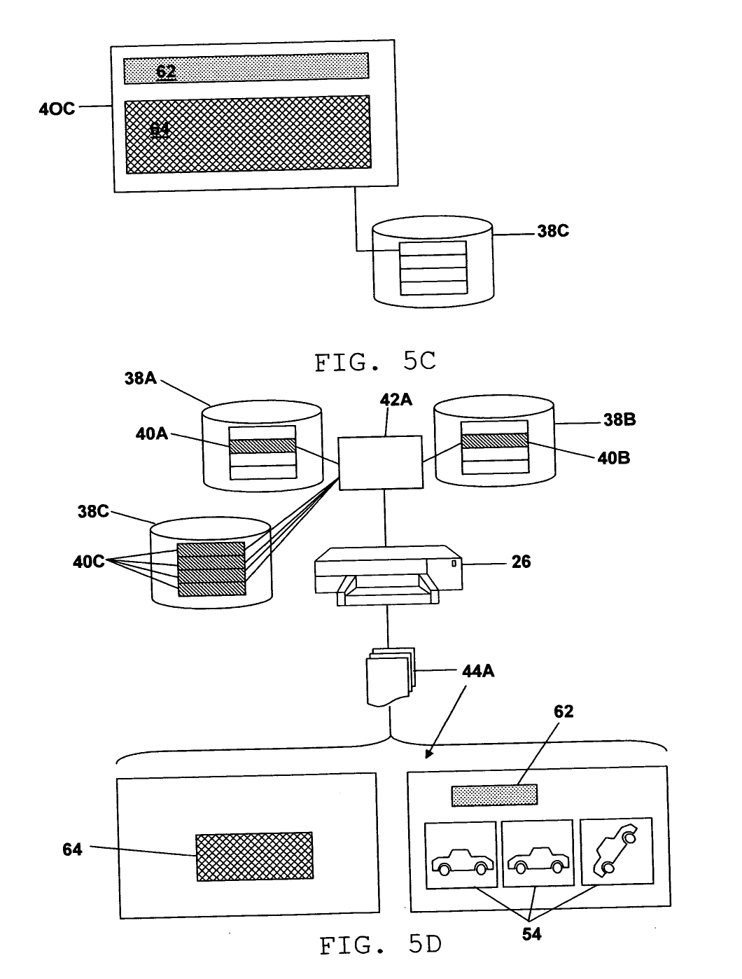

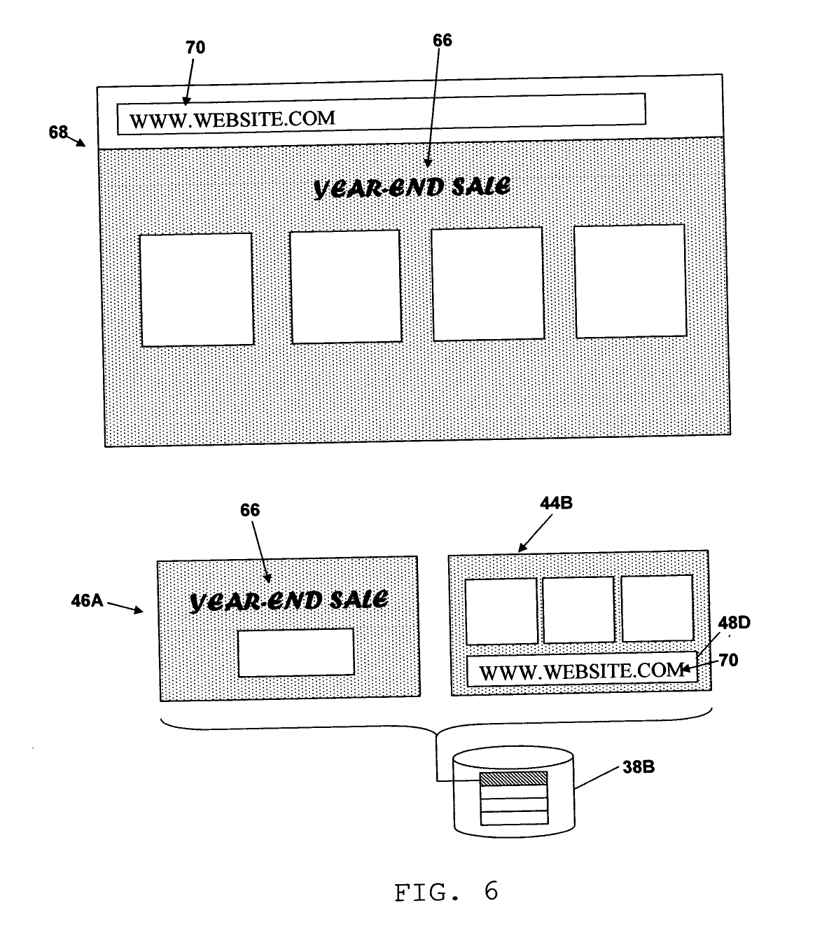

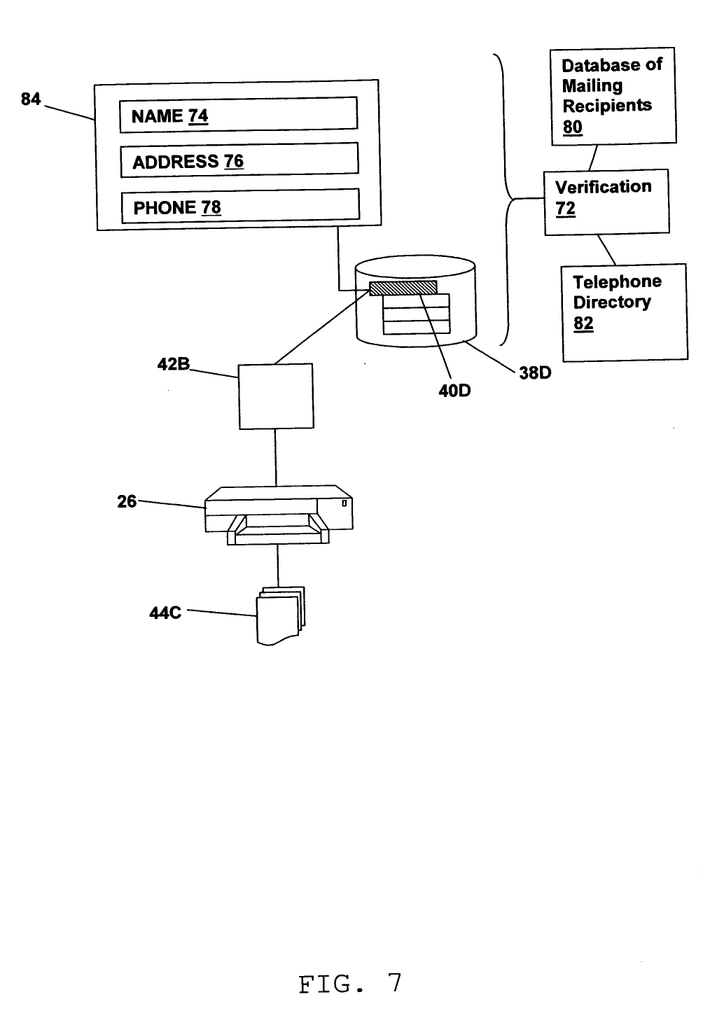

Each document 44 preferably includes information corresponding to at least one of the selected business items 40. The inclusion may be performed by providing a general document layout or template 46 (FIG. 5B) for all documents 44 to be printed. The terms “document layout,” “electronic template” and “template” are used interchangeably herein to denote electronic formatting or instructions for electronic formatting for production of documents using a variable data digital press 26, and should not be understood as reference to a physical template such as may be employed on a physical press by a traditional printing service. The template 46 describes static information common to all documents and also contains areas 48 for insertion of the variable data business items 40 selected from the collections of data 38. The variable data for each document 44 is reproduced by the variable data digital press 26 as each document 44 is generated, so that a series of documents 44 is built using a single template 46 and a series of selected business items 40 that are inserted into the designated areas of the template 46. It should be understood that a template 46 need not contain any static information and may consist of only one or more areas 48 for insertion of variable data.

As an example, a series of personalized postcards (not shown) may be generated by using a single template 46 that designates an area on one side for a name and mailing address of an intended recipient. The other side of the postcards may have a first designated area for the first name of each intended recipient and a second designated area for a digital image of the intended recipient. Business items from two collections of data 38 may then be selected, a first collection 38 having names and mailing address of intended recipients, and a second collection 38 having digital images of the intended recipients. After selecting the intended recipients, the values corresponding to name, address, and digital image, or the file location of a digital image, are used to generate input files 42 for the variable data digital press 26. The input files 42 are then transferred to the variable data digital press 26 for producing a series of postcards personalized for each intended recipient.

It should be clearly understood that the selected business items 40 may include any type of information relevant to a business purpose that may be represented in print, including, but not limited to, text, images, colors, or designs. It should also be understood that significant benefits may be obtained by using two or more templates 46 for personalized documents 44 generated by the variable data digital press 26. In addition, the templates 46 themselves may be provided in a collection of data 38 which may be selected for generation of documents, or may be selected to correspond to other selected business items. For example, a first template having one color may be selected for each female recipient, and a second template having a second color may be selected for each male recipient. As another example, a document may be created using a combination of templates. Alternatively, no template providing formatting information may be provided at all if the variable data digital press 26 is capable of producing documents 44 using a default or built-in format.

Additionally, one or more templates or document is layouts 46 may be provided, either as a direct layout such as an image, or as a series of processing steps or commands whose execution result in proper print formatting information. Templates 46 may be stored in a collection of business data 38 such as a database or as a file in a preferred portion of memory 16, which may be referred to, referenced by, or linked to a value in a database or collection of template information. Data for locating and retrieving the templates 46, such as a file name and file path, or database name and record key value, or pointers to memory locations, for example, may then be used to access a file or portion of memory 16 corresponding to a desired template 46. In this manner the templates 46 may be easily located and retrieved.

It should also be understood that it is within the spirit and scope of the present invention that all types of printable documents may be produced by the method of the current embodiment, including but not limited to postcards, letters, envelopes, posters, magazines, brochures, and books. Additionally, the method of the present invention may be applied to printing on a single side or both sides of a sheet of paper or printing material, as well as printing onto a sheet that may already have a pre-existing pattern or design.

Inventory Management

In accordance with another embodiment of the present invention, at least one collection of business data 38 corresponds to inventory items 50. The business method of using different and variable business data for various and separate business uses, and in particular for uses involving inventory, further comprises the steps of collecting information 52 corresponding to a new inventory item 50, the information 52 comprising at least one digital image of the new inventory item 50, adding the collected information 52 to the collection of business data 38 corresponding to inventory items, and modifying the collection of business data 38 corresponding to inventory items in response to a removal of an inventory item 50A.

In FIG. 4A, a new item of inventory 50, depicted as a car, is introduced. Information 52 relating to the new inventory item is collected and recorded. The collected information 52 further includes a digital image 54, preferably a photograph provided by a digital camera 56, although any method of acquiring a digital image 54 may be used, such as a digitized image by a non-digital camera or an artist's rendition, for example. The collected information 52 is then added to a collection of business data corresponding to inventory items 38A.

As an example, in an application of the present invention supporting marketing for a car dealership, a new inventory item 50 may be a car. Examples of information 52 that may be collected corresponding to a car include, but are not limited to, the vehicle identification number (VIN), mileage, exterior and interior color, make, model, model year, options or options packages present in the car, engine type, transmission type, date of acquisition by the dealership, dealership price for the car, and desired sale pricing for the car. The information 52 is then stored in a collection of business data 38A corresponding to inventory items 50.

Additionally, a single or multiple digital images 54 of the car 50 may be taken and stored for later use in marketing documents 44. The digital images 54 may be stored directly with other data relating to inventory items. Alternatively, the images may be stored in a separate collection of business data (not shown) such as another database or as a file in a preferred portion of memory. Data for locating and retrieving the images, such as a file name and file path, or database name and record key value, or pointers to memory locations, for example, is may then be included with other information 52 corresponding to the car 50. In this manner the images 54 of an inventory item 50 may be easily located and retrieved although not necessarily stored in the same collection of business data 38A as other information such as VIN and model year.

When removing an inventory item 50A from inventory, it is desirable to modify the collection of business data 38A corresponding to inventory items to reflect that the item 50A is no longer available. One method, depicted in FIG. 4B, includes locating in a collection of business data 38A the business item 40A corresponding to the removed inventory item 50A, and modifying (step 56) one or more values indicating that the status of the inventory item 50A has changed. For example, the modified values may include, but are not limited to: the date of removal from inventory; the nature of removal such as by sale, destruction, or return to the manufacturer; the sale price of the item; or the purchaser's name. Another modification may include digital images 54 or the location of digital images, such as a digital image 54 of the inventory item 50A in the possession of the purchaser, for use in follow-up materials for the purchaser. Additionally, a value relating to the state of an inventory item may be modified to reflect that is the inventory item 50A is currently unavailable for sale, such as when a customer is in the process of purchasing the inventory item 50A or when the item is being repaired or refurbished.

An alternative method of modifying the collection of data 38A corresponding to inventory items in response to a removed inventory item 50A is depicted in FIG. 4C. In this method, the values 40A corresponding to the business item 40A relating to the removed inventory item 50A are removed from the collection of business data 38A. The values 40A may be stored in another collection of data (not shown), for example, an archive of removed inventory items, or the values may simply be discarded.

The addition of new information 52 corresponding to a new inventory item 50 into a collection of business data 38A corresponding to inventory items may be performed manually or may be performed as an automated process occurring at a designated time, such as a batch process that runs in the early morning when system resources are available for use without disrupting business operations. Another possibility is having scheduled times for addition of new information 52 to the collection of business data 38A corresponding to inventory items, such as at the close of business on scheduled days of delivery of new inventory items 50.

Similarly, the modification of information (step 56) in a collection of data 38A corresponding to a removed item of inventory 50A may also be performed manually or by an automated process by the methods outlined above. Although two examples of modifying the collection of business data 38A have been disclosed, that of modifying values to indicate the removal from inventory and that of removal of the information 40A from the collection of business data 38A, is should be clearly understood that other methods, both manual and automated, are within the scope of the present invention.

Using a car dealership as an example, an inventory item 50 consists of a car. Preferably, when the car 50 was acquired by the dealership, pertinent information 52 corresponding to the newly-acquired car was collected such as in the example provided above, and saved in a collection of business data 38A corresponding to inventory items. When the car 50A is sold, the information 40A stored in the collection of business data 38A corresponding to inventory items may be modified by adding a date of sale, a sales price, the name or identifying code of the purchaser, and a digital image or a link to a digital image 54 showing the purchaser alongside or within the car 50A.

In order to reflect the removal of the car 50A from inventory as soon as possible, the modification of information (step 56) may be preformed immediately following the sale. For example, the salesman or manager responsible for the sale may run computer software designed to prompt for the pertinent sale information and to access and modify the collection of inventory items 38A with the provided information. Alternatively, the information may be modified manually, such as by a database administrator or operator supporting the business functions of the dealership.

Prompt modification of the information in the collection of business data 38A corresponding to inventory items to reflect the sale of the car 50A may be desirable for a number of reasons. Such reasons include ensuring accuracy of daily activity reports for dealership management, or to update appointment calendars for other salesmen that may plan to show the newly-sold car to other potential buyers. Another reason would be to provide close to real-time inventory updates if the dealership hosts or is affiliated with a website displaying available inventory for online sale or to generate consumer interest. Yet another reason would be if the dealership engages in aggressive marketing techniques that involve fast preparation and distribution of literature such as direct mail or daily advertisements showcasing available inventory items.

However, the dealership will likely desire to retain the modified information in the collection of business data 38A corresponding to inventory items for a predetermined period. For example, the information 40A may want to be retained until a suitable period has passed to ensure a purchaser's check has cleared. If the sale is conditioned on a lender's approval, the information may want to be maintained until approval of a loan is verified. Likewise, if the car 50A may be returned in a jurisdiction honoring a buyer's remorse period, or may be returned under a time-limited satisfaction guaranty, for example, then the information 40A relating to the car 50A may be retained in the collection of business data 38A corresponding to inventory items until such periods have passed.

When one or all such predetermined periods has passed, and the sale of the car 50A is firmly established as a completed transaction, the dealership may find it desirable to remove the information 40A relating to the sold car 50A from the collection of data 38A corresponding to inventory items in order to preserve computer resources and maximize efficiency in database operations involving inventory items. The dealership may likely archive the information into another collection of business data (not shown) for later reference, such as a database of historic sales activity, or a paper record stored in a file cabinet, for example. The removal of the business item 40A, the information relating to the sold car, from the collection of business data 38A corresponding to inventory items is not necessarily affected by the considerations prompting immediate modification of information following the sale. The removal of the business item 40A may be performed by a daily process that locates, archives, and then removes all items 40A having a date of sale prior to a predetermined period. Likewise, such a process may be performed at other regular periods such as weekly, monthly, or quarterly, for example. Alternatively, the removal and archiving process may be preformed in response to other considerations, such as a database of inventory items growing to a specified limit.

The desirability of maintaining a collection of business data 38A corresponding to inventory items is easily understood further in the context of marketing products or services using the variable data document production method of the present invention. Items of inventory 50 may be selected to be promoted in sales materials so that information about the promoted items 50, which may consist of or include images 54 of the promoted items, in addition to pertinent information like options, mileage, and price. Furthermore, if a provided collection of business data 38 corresponds to mail recipients, selected recipients may receive personalized mailings prominently featuring one or more inventory items 50.

Furthermore, significant time and expense may be obtained by cross-platform publishing, involving designing and preparing advertisements that may not be printed using the variable data digital press 26 of the present invention. For example, to prepare an advertisement for a newspaper or trade publication, typically a car dealership must select which vehicles will be featured, send a representative out to photograph the selected vehicles, compile additional information on the vehicles that is desired to be included, and forward the pictures and information to a printer or art department. The printer or art department then prepares the advertisement layout and sends a proof to the dealership for review. If acceptable, the advertisement may then be sent to the publishing body. If not acceptable, as frequently occurs, the process must be repeated until the dealership is satisfied with the result.

However, maintaining a current collection of business data 38A corresponding to inventory which includes digital images 54 provides the dealership with the ability to quickly select images and relevant information of inventory to be featured. By providing a standard advertisement layout, or a selection of such layouts, the dealership may design the entire advertisement, and may create its own proof using the variable data printing of the present invention, if desired. Once created, the advertisement is easily delivered to the publishing body, for example, by saving the advertisement in a standard electronic file format such as a PDF file, and transmitting the file electronically such as via email or ftp applications. In this manner, an advertisement may be generated and transmitted potentially in a matter of minutes directly by the dealership staff.

Other benefits may be obtained by maintaining a collection of business data 38A corresponding to inventory items. For example, reporting functions such as for sales performance, inventory turnover, composition, or costs, revenue due to sales, or any other report or analysis that is a function of or relates to inventory may be incorporated into the present method.

Again using a car dealership as an example, periodic reports (not shown) may be generated such as a personalized report for each salesperson showing weekly sales and activities. In this example, a collection of business data 38 corresponding to sales personnel may be provided and persons to receive a report selected, such as a sales team or the entire sales staff of a dealership. For each sales person selected, the collection of business data 38A corresponding to inventory items may be queried to generate information relating to the items sold by that sales person during a desired period. A series of personalized reports may then be generated by a variable data digital press 26 for distribution to the sales personnel, showing sales, revenue generated, purchasers, and possibly including images of the items sold or purchasers of the items, or both. Variations of such reports may be provided for various levels of a management hierarchy, or for financial or operating officers of the dealership company, for example.

Production of Personalized Marketing Documents

In accordance with another embodiment of the present invention, a business method of using different and variable business data for various and separate business uses is used to produce personalized marketing documents as depicted in FIGS. 5A, 5B, 5C, and 5D. In the present embodiment, a first collection of business data 38A corresponds to inventory items (FIG. 5A), a second collection of business data 38B corresponds to document layouts (FIG. 5B), and a third collection of business data 38C corresponds to mailing recipients (FIG. 5C). The selecting step of the present invention includes selecting at least one inventory item 50, at least one document layout 46, and at least one mailing recipient. The printing step generates at least one personalized document 44A for each selected mail recipient, with each document 44A having information corresponding to one of the selected mail recipients 40C and at least one of the selected inventory items 40A in conformity with the selected document layout 40B (FIG. 5D).

FIG. 5A depicts a first collection of business data 38A corresponding to inventory items, using a car 50 as an example. Pertinent information 52 pertaining to the inventory item is stored in the collection of business data 38A; in the case of a car the pertinent information may include the VIN, mileage, exterior and interior color, make, model, model year, options or options packages present in the car, engine type, transmission type, date of acquisition by the dealership, dealership price for the car, and desired sale pricing for the car. Additionally, a single or multiple digital images 54 of the car may be stored directly in the collection of business data 38A corresponding to inventory items, as depicted in FIG. 5A, or the images may be stored in a separate collection of business data (not shown) such as another database or as a file in a preferred portion of memory, and information for locating and retrieving the images, such as a file name and file path, or database name and record key value, or pointers to memory locations, for example, may then be included with other information corresponding to the car 50 in the collection of business data 38A corresponding to inventory items.

FIG. 5B depicts a second collection of business data 38B corresponding to document layouts 46. As illustrated in FIG. 5B, each document layout 46 may define the front 56 and back 58 of a document, such as a postcard. Preferably, the document layouts 46 define regions 48 of the document for insertion of variable data corresponding to the selected mailing recipients and inventory items. For example, in FIG. 5B regions 48A are defined for insertion of a recipient's name and address on one side 56 of a postcard, while regions for the recipient's name 48B and images of inventory items 48C are defined on the other side 58. The remaining regions 60 of the document layout may contain non-variable data such as images, colors, or text that remain constant for all documents to be printed.

Although a single document layout 46 defining both sides of a postcard is depicted in FIG. 5B, it should be understood that the collection of business data 38B corresponding to document layouts may contain layouts 46 for various types of documents. For example, layouts for letters, flyers, posters, various sizes of advertisements for magazines or newspapers, banners, or business cards may be included, as well as layouts any other document type. In addition, each document layout 46 may comprise information for only a single side of a document, or may only comprise information for only a portion or several portions of a document, so that several document layouts may be combined to generate a complete document. Furthermore, the regions of data 60 not defined for insertion of variable data may not comprise static information such a colors, images, or text that remain constant for all documents to be printed, and may instead contain no printing information, such as when used for generating documents using paper or a printing material having such information already present on the material.

FIG. 5C depicts a third collection of business data 38C corresponding to mailing recipients. As illustrated schematically in FIG. 5C, the information stored 40C may simply consist of a name 62 and a mailing address 64 for each mailing recipient. However, significant benefits may be obtained by storing additional or alternative information or storing the information in a more granular format. For example, first and last name, street address, city, state, and zip code may be stored as independent values for a single recipient to facilitate operations such as selecting all mailing recipients within a certain zip code or range of zip codes, or within a certain city or cities. Additional information that may provide benefits includes, but is not limited to, postal regions for efficiency or lower cost in mailing, the gender of the recipients for specific gender-oriented documents, credit score, homeownership, cars currently owned, and a record of previous mailings sent to each mail recipient for tracking efficiency or response rates to mailings, or to otherwise allow to application of business marketing policies to recipients. For example, a business may determine that maximum response rates are obtained if a recipient receives no more that two mailings per month, or perhaps if mailings are received at an ever-increasing frequency such as monthly, then weekly, and finally daily. As another example, a record of previous mailings may allow a business to determine which types of featured inventory the recipient has already received and determine whether the particular mailing being presently prepared should also be sent to the recipient in accordance with a desired marketing or sales policy.

FIG. 5D depicts the selection of business items including mailing recipients 40C from a collection of business data 40C corresponding to mailing recipients, items of inventory 40A from a collection of business data 40A corresponding to inventory items, and a document layout 40B from a collection of business data 38B corresponding to document layouts. The information for the selected business items may then transformed into a format such as one or more input files 42A understood by the variable data digital press 26, as previously discussed. The variable data digital press 26 then produces at least one personalized document 44A for each selected mail recipient, with each document 44A having information corresponding to one of the selected mail recipients and at least one of the selected inventory items in conformity with the selected document layout.

Continuing the specific examples depicted in FIGS. 5A, 5B, and 5C, the personalized documents 44A produced are two-sided post cards having a format as defined in the selected document layout 46 shown in FIG. 5B. At least one personalized postcard 44A is produced for each selected mailing recipient 40C by having the mailing address 64 of the mailing recipient inserted in the region defined for mailing addresses 48A and the name of the mailing recipient 62 in the region defined for the mailing recipient's name 48B. Additionally, each of the regions 48C defined for an image of inventory items contains an image 54 of a selected inventory item 50; in this case, three different views of a single car are printed, one in each defined region 48C.

It should be clearly understood that the selection of the document layouts, mailing recipients, and inventory items may be accomplished by any desired method. For example, mailing recipients may be selected according to proximity to a geographic location, such as by selecting a business store location and selecting all recipients within a determined distance from the location. Another example of selecting mailing recipients based on proximity to a location is by determining a desired number of recipients and selecting all recipients located within an ever-increasing radius from the location until the desired number of recipients has been found. Yet another example may include constraining the selected recipients to be located within one or more specific postal regions to reduce the cost or increase the efficiency of mailing.

Similarly, the selection of inventory items 50 to be included in the personalized documents 44A may be preformed by any desirable method. One or more inventory items may be selected, and information corresponding to any or all of the selected inventory items 40A may be inserted into any or all of the personalized documents 44A. Examples of simple selection methods for inventory items 50 to be featured in the personalized documents 44A include only selecting new items of inventory, or a single or multiple items of inventory featuring a below-market price to encourage purchasers to respond, or items that have been in inventory the longest to encourage inventory turnover, or the selection may be simply random.

More sophisticated methods may be employed to select inventory items 50 to be included in the personalized documents 44A. For example, the selection may be gender-specific so that male recipients receive information on one inventory item or group of inventory items and female recipients receive information on another inventory item or group of inventory items. As a specific example, for personalized documents promoting vehicles for sale, trucks or high-performance cars may be selected for male recipients while fuel-efficient, safety-oriented, or luxury models may be selected for female recipients. Likewise, selection of inventory items may be performed by selecting items according to the recipient's location. For example, low-priced inventory items may be selected for mailing recipients in areas having a low median income, while high-priced inventory items may be selected for mailing recipients in areas having a high median income. Other characteristics of the recipients' geographic area may be used to select inventory items for the personalized documents. As an example, a car dealership may select trucks for rural recipients and compact cars for urban recipients.

Furthermore, although as FIG. 5D illustrates an image 54 of the selected inventory item printed on the personalized documents 44A, significant benefit may be obtained by the personalized documents not having images 54 alone or not having images at all, but instead having other information of the selected inventory item. For example, a personalized document promoting a car for sale may provide a description of the make, model, year, and sale price of the car, either alone or in addition to an image of the car. As another example, if the method of the present invention is used to promote inventory items sharing a common characteristic, a list of available inventory items may be determined to be a more efficient use of available space in a personalized document than a fewer number of images. As a specific example, if the personalized documents are intended to promote vehicles for sale to persons that have recently filed for bankruptcy or have credit deficiencies, then a list of information of vehicles in inventory that are available for purchase at a low price for which a bankruptcy or poor-credit customer is likely to qualify for financing may be provided to demonstrate the availability of a large number of affordable vehicles for purchase from the sender of the personalized document.

Promotional Website

In accordance with another embodiment of the present invention, each selected document layout 46A has a theme 66. The business method of using different and variable business data for various and separate business uses further comprises the step of automatically generating a promotional website 68 having the theme 66 of at least one selected document layout 46A, where the promotional website 68 provides information corresponding to the selected inventory items 40C. Each printed document 44B includes an internet address 70 corresponding to the promotional website 68. The theme 66 includes at least one of a color and a slogan.

Referring now to FIG. 6, an example of the present embodiment is depicted. A document layout 46A having a theme for a promotion is selected from a collection of business data 38B corresponding to document layouts. In FIG. 6, the selected document layout's theme 66 comprises both a slogan and a color. A website 68 is automatically generated that also shares the theme 66 of the document layout 46A. The website address or uniform resource locator (URL) 70 for the promotional website 68 is provided as data to be printed in a variable data region 48D defined for such a purpose in the document layout. Alternatively, the URL 70 for the promotional website may be added as static information to the document layout rather than in a variable data region 48D. The personalized documents 44B, depicted in FIG. 6 as postcards, may then lead the recipients to visit the promotional website 68 to see more information on the inventory items featured in the personalized documents or to see additional inventory or other information relating to the promotion.

Although the theme 66 depicted in FIG. 6 comprises both a slogan and a color, it should be clearly understood that it is within the spirit and scope of the present invention that a theme 66 may be only a slogan or only a color, or any combination of slogans or colors. For example, a deep-discount sale promotion may feature a specific shade of blue as the theme, or a Memorial Day sale promotion may feature the colors red, white, and blue in an arrangement reminiscent of an American flag. Additionally, although the promotional website contains information relating to the selected inventory items 40A relating to the promotion, the personalized documents 44B produced for the mailing recipients may not feature all of the selected inventory items 40A, and each personalized document 44B may instead contain information on only a few or a single inventory items, as space permits.

Preferably, the website 68 is made available to Internet visitors for the duration of the promotion. Promotions of limited time, such as a three-day sale, may have a predetermined ending period, beyond which preferably the website 68 is removed from public Internet access. Websites 68 corresponding to promotions of indefinite duration may remain available indefinitely, until the promotion ends. Alternatively, a website 68 may remain available following the end of a promotion but modified to announce to Internet visitors that the promotion has ended, and preferably providing information on an upcoming promotion or contact information for a visitor to inquire about inventory items that may remain available.

The present invention provides the benefit of being able to rapidly generate a multi-media promotion campaign at low cost. Preferably, software run on a computer 12 is used to enable the selection of a document layout 46A, inventory items 50, and mailing recipients from the corresponding collections of business data 38 such as databases. Once the selections have been made, a promotional website 68 may be automatically generated that duplicates the theme 66 of the selected document template 46A and that features information corresponding to the selected inventory items 40A. The production of personalized documents 44B on a variable data digital press 26 for mailing to selected recipients may be accomplished quickly, enabling a user of the software to create and launch a themed promotional event without needing artistic skills or requiring the services of a professional graphic artist or traditional printing service.

Lead Management

In accordance with another embodiment of the present invention, a business method of using different and variable business data for various and separate business uses is used for management of customer leads as depicted in FIG. 7. A first collection of business data 38D corresponds to customer leads and has values corresponding to a name 74, an address 76, and a phone number 78 of each customer lead. The method further includes adding values to the collection of business data 38D corresponding to customer leads in response to a new customer lead 84, and verifying values of the collection of business data 38D corresponding to customer leads by performing at least one of an address verification against a current database of mailing addresses 80, a phone verification against a telephone directory 82, and a redundancy verification to prevent redundant customer leads. The step of selecting includes selecting at least one new customer lead 84, the step of printing produces a personalized follow-up document 44C for mailing to each selected new customer lead 84, and each personalized follow-up document 44C has information 40D corresponding to the selected new customer lead 84.

A customer lead refers to a potential purchaser that has demonstrated some level of interest in the products or services offered. As opposed to mass-mailing recipients, customer leads represent potential or prior customers that are considered more likely to purchase a product or service and therefore are more deserving of special attention in marketing efforts. A new customer lead may result from any number of events, including but not limited to an incoming telephone call, email, facsimile transmission, a decision to opt into mailing and promotional lists, a referral, or physically appearing in a business' showroom or retail sales establishment.

Ideally, information pertaining to a customer lead 40D contains all available forms of contact information such as phone numbers, fax numbers, email addresses, and mailing addresses, in addition to information such as a record of every successful and attempted contact with the customer lead, the gender, income, credit status, marital status and other demographic information of the customer lead, and the stated or likely product preferences of the lead. As a practical matter, however, rarely is all of this information available. One method of obtaining some desired lead information that is presumptively accurate is by providing a scanner capable of capturing information from a driver's license or other document of a potential customer, such as by image capture or by reading a bar code or magnetic stripe, although other desired information may have to be obtained through other means. Often, only a name and address or telephone number may be obtained, such as when a potential customer decides to not reveal personal information. Similarly, a potential customer may provide false information either deliberately or accidentally, such when a scanned driver's license has not been updated to reflect a new address. In addition, false customer lead information may be fabricated by someone having an incentive to do so, such as a salesperson that receives a commission for generating leads or is required to fulfill a quota of new leads.

Because each customer lead represents a potential buyer, and is therefore a primary candidate for marketing efforts, a collection of customer leads that contains accurate information allows a sales or marketing effort to operate more efficiently than a collection of leads having incorrect information. Sales calls, faxes, and mailings sent to incorrect destinations consume valuable time and resources that may be more productively employed elsewhere. Preferably, therefore, the customer lead information is verified in at least one of, and preferably all of, the following ways.

An address of a customer lead may be verified by using a current database of mailing addresses 80 such are available from federal, state, or local government agencies such as the Post Office, or from other sources, such as commercially prepared databases available on the internet. A customer lead having an incorrect address, whether provided deliberately or otherwise, can be detected and the faulty information removed from the customer lead information.

A telephone number of a customer lead may be verified by comparing the provided information, such as a name and mailing address, to an available current telephone directory 82. This verification may be employed electronically be accessing a reverse look-up directory such as are available on the internet. A reverse look-up directory allows a user to enter a telephone number and view the name and address, if available, of the person corresponding to the phone number. Similarly, a standard telephone directory, either electronic or traditional, may be employed by looking up a customer lead's name to see if a matching telephone number is listed.

A third verification is to catch redundant information. A customer lead that appears twice in a collection of business data 38D corresponding to customer leads can be the source of confusion and frustration to the potential customer, as marketing efforts are likely to target the potential customer more frequently than intended. Similarly, redundant customer leads consume business resources and introduce opportunity costs as marketing efforts and resources are repeated on a single lead at the expense of other potential purchasers represented by other customer leads. A redundancy check may simply compare customer lead information such as a name against other customer leads in the collection of business data and flag redundancies for manual review or automatically merge or remove the redundancies.

The verification of customer lead information is preferably performed as a new customer lead 84 is added. Preferably, a salesperson meeting with a potential customer will verify the information while still in the presence of the customer, such as by entering data into a computer program that automatically verifies the provided information in real time, allowing the salesperson to notify the potential customer of any inconsistencies and make corrections immediately. However, often this is not possible, such as when a salesperson takes manual notes on the potential customer information on a prepared document commonly referred to as a lead sheet or upcard, and provides the information for later entry into a collection of business data 38D corresponding to customer leads. In this case, preferably the verification of the customer lead information is preformed prior to the addition of the new customer lead information into a collection of business data 38D corresponding to customer leads.

In the following particular example, benefits from an immediate redundancy check for a car dealership are readily apparent Several Internet services exist that allow a website visitor to browse a selection of vehicles. The Internet services then electronically transmit data to participating dealerships containing the visitor's information and details of the visitor's visit to the website. This transmitted data amounts to a customer lead, and the dealership is typically billed a predetermined amount for each such lead provided. However, a single consumer may visit several of these Internet services when shopping for a vehicle, typically visiting multiple sites within a brief period of time. One result of such consumer behavior is that a dealership subscribing to more than one of these Internet services may receive multiple transmissions of data relating to a single potential customer, and consequently will be billed by multiple services for information corresponding to a single customer lead.

By providing a redundancy check when such information is received, a dealership may elect to accept new customer leads but elect to not accept subsequent transmissions of redundant information pertaining to the same customer lead from other Internet services. For example, a dealership may maintain a collection of business data corresponding to customer leads provided by the Internet services in a separate database (not shown) so that as electronic transmissions are received, the information may be quickly compared to existing customer lead information and a decision whether to accept or reject each transmission may be made. Although the redundancy check may be preformed against all customer lead data, it may prove more efficient if the separate database only retains such information for a relatively short duration, such as a few hours or days, as may be statistically determined to encompass a typical vehicle shopper's visits to the various internet services. Maintaining information for only a short period may provide the benefit of small database size and quick database access time for comparisons. In this manner, the dealership expenses may be reduced dramatically by only paying a single time for original customer lead information, in addition to saving time and resources that may be spent following up on redundant leads as if each represented a separate potential customer.

However, substantial benefits may also be obtained by not verifying the new customer lead information prior to adding it to the collection of business data corresponding to customer leads, as long as the verification is preformed before the lead information is used for sales or marketing efforts. Additionally, periodic verification of information corresponding to customer leads may prove beneficial to determine when customer lead information becomes invalid, such as when the potential customer moves or changes phone numbers.

In order to maintain the interest of a potential customer, follow-up communications with the potential customer should be preformed as quickly as possible following a contact with the potential customer, whether the contact is by phone, email, in person, or any other form of contact. In the present embodiment, the follow-up communication is preformed by selecting new customer leads 84 from the collection of data 38D corresponding to customer leads and generating at least one personalized follow-up document 44C for each new customer lead. The personalized follow-up document 44C may be a letter or postcard or any other document suitable for mailing to the new customer lead 84. Preferably, the selection of new customer leads 84 and the production of personalized follow-up documents 44C are preformed daily, either manually or by an automated process, to ensure prompt follow-up communication with the potential customer.

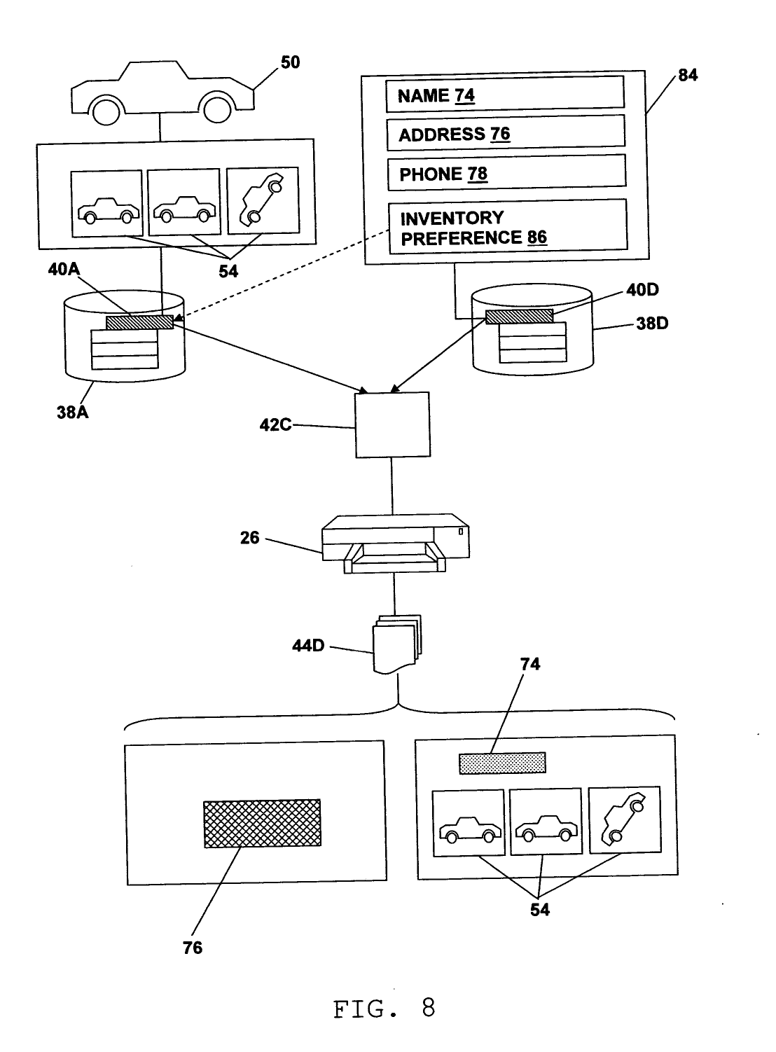

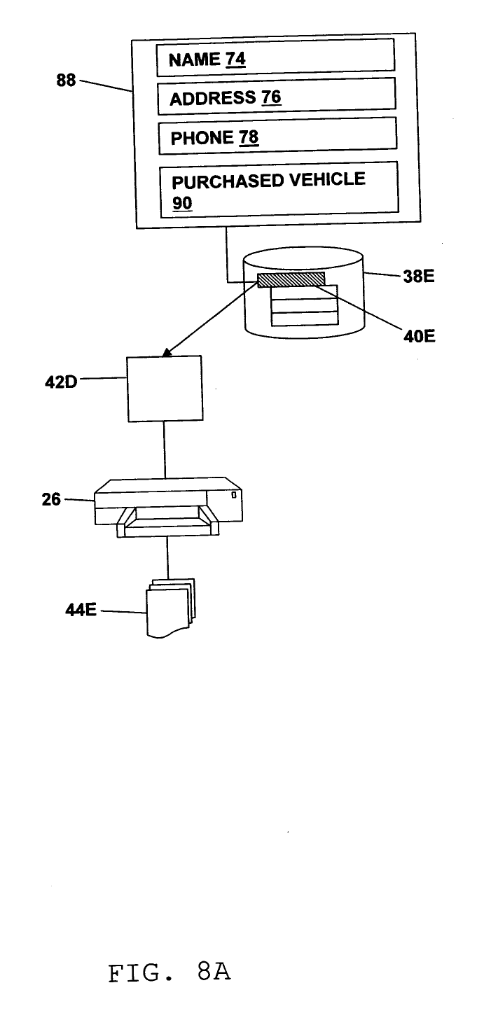

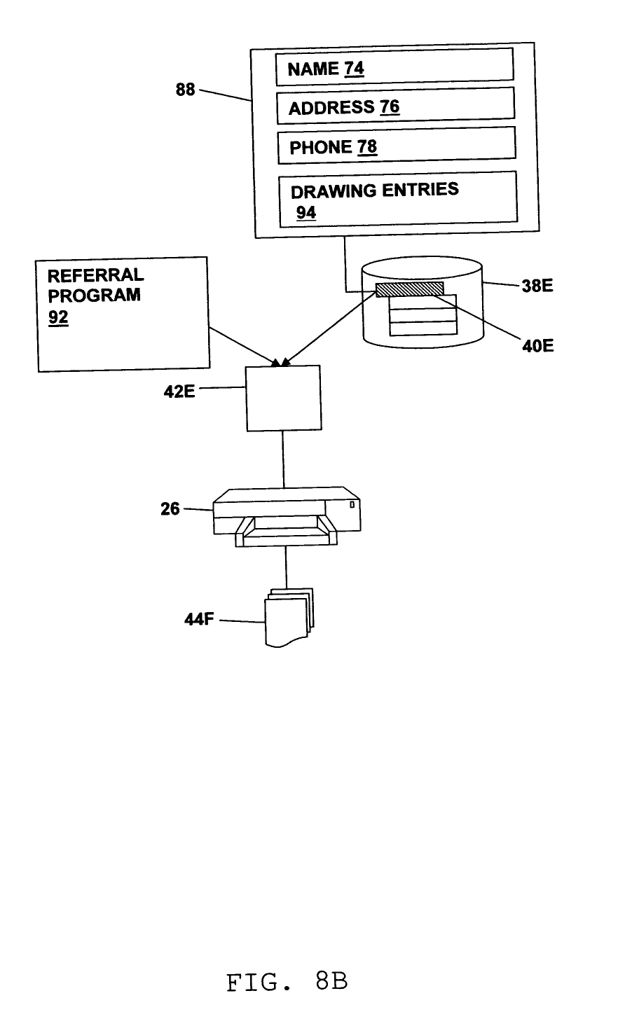

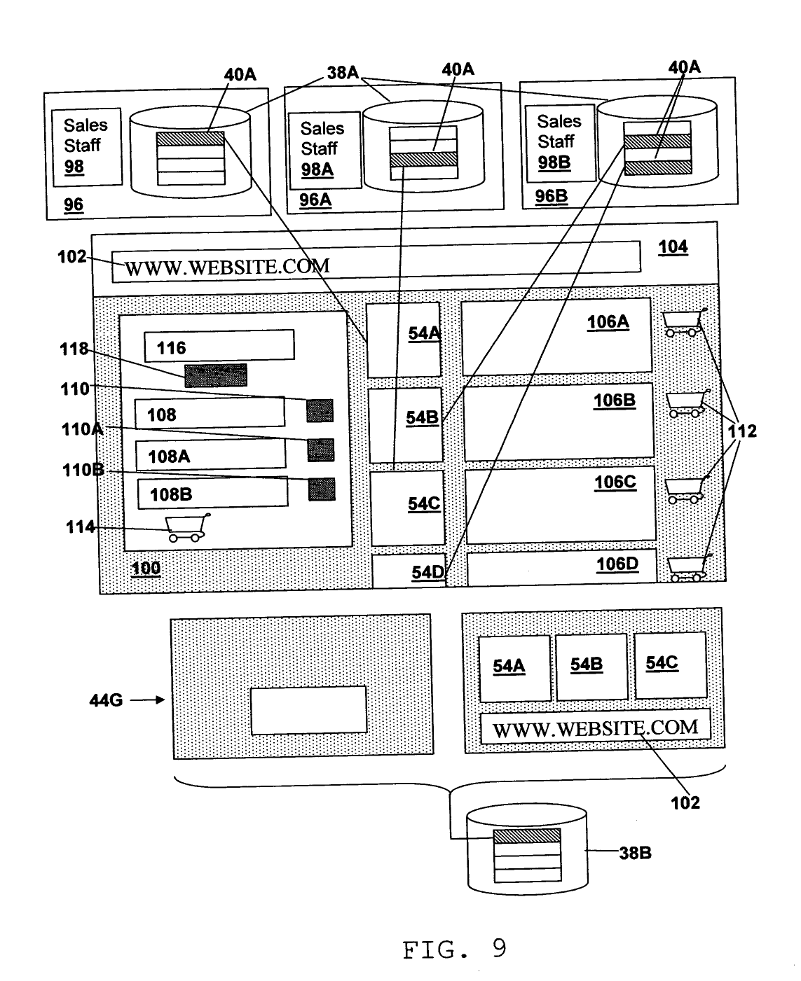

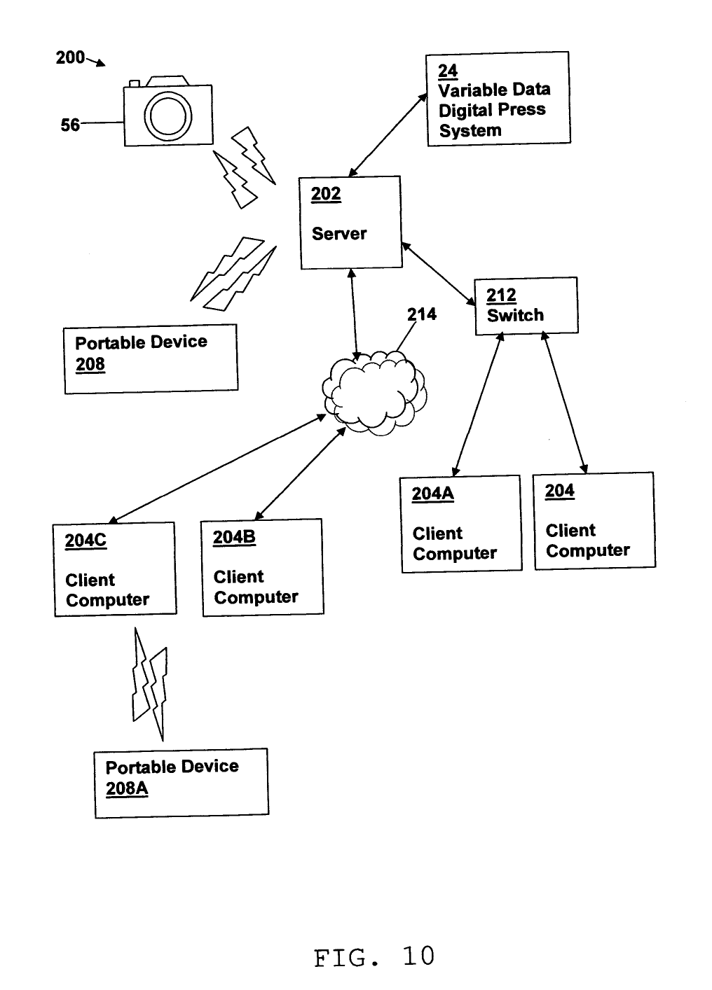

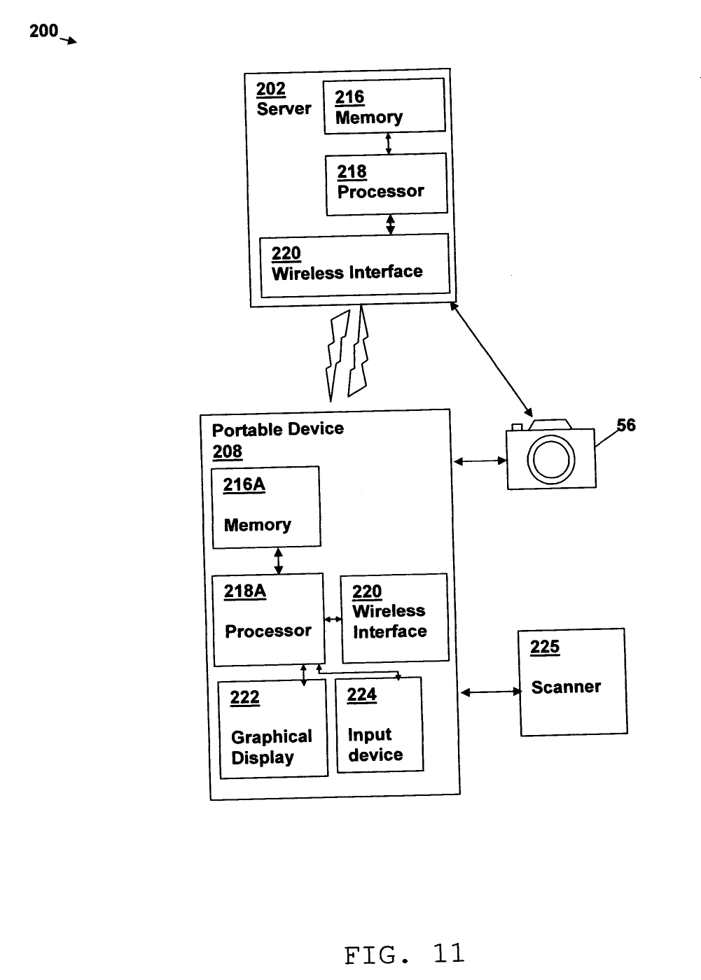

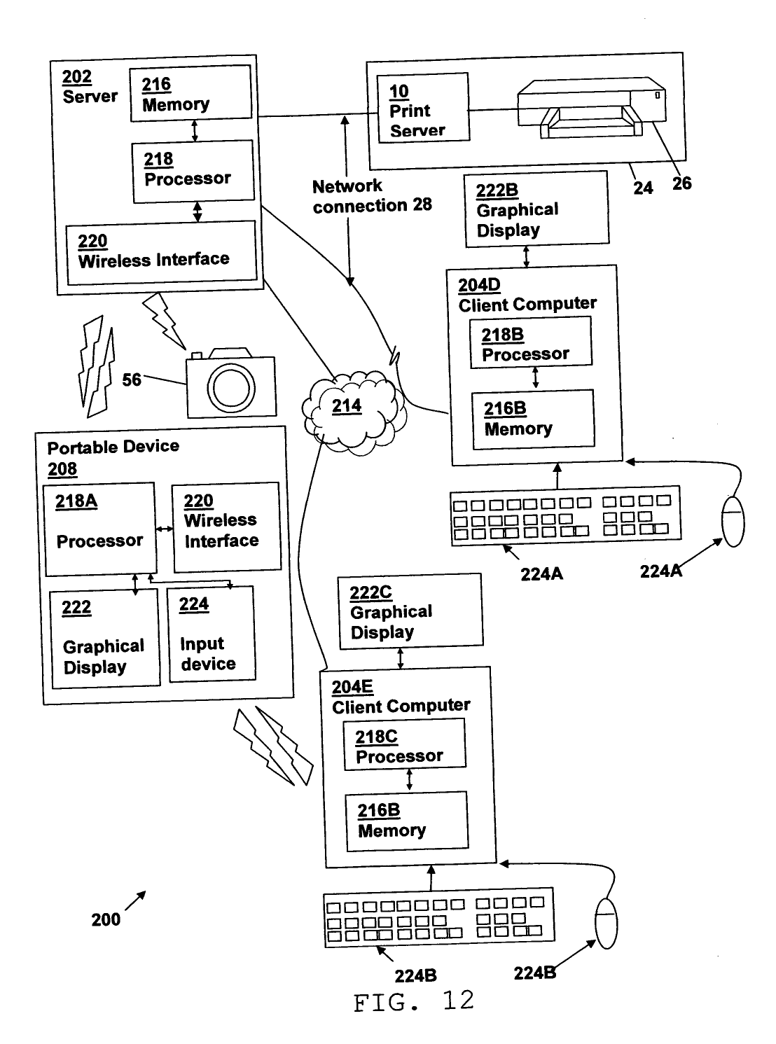

In order to maximize the effectiveness of the personalized follow-up documents 44C, preferably the documents contain information relating to one or more products of interest to the customer lead. In accordance with another embodiment of the present invention as depicted in FIG. 8, a second collection of business data 38A corresponds to inventory items. The step of selecting further comprises selecting at least one inventory item 50 for each selected new customer lead 84 by at least one of correlating said inventory item to preferences typical of a demographic category of the selected new customer lead, selecting inventory items determined to be of actual interest to the selected new customer lead, and selecting an inventory item that is a subject of a promotion. Each personalized follow-up document further has information 52 corresponding to the at least one selected inventory item for the selected new customer lead 84.

As depicted in FIG. 8, using a car dealership as an example, the information 84 relating to a customer lead contains information indicating a car of particular interest to the potential customer. This interest may be specified by the potential customer in a telephone call, and email or fax, or may be the result of a personal visit to the dealership where the potential customer expressed or implied interest in one or more vehicles for sale. In creating the personalized follow-up documents 44D, one or more cars of interest 50 is selected, and information 52 about the car or cars of interest such as images is provided. FIG. 8 depicts the personalized follow-up document as a postcard 44D, with three images 54 of the car of interest provided, along with personalized information corresponding to the customer lead such as her name 74 and address 76.

If information about a customer lead's actual preference for one or more items of inventory 86 is not available, other methods for selecting inventory items 50 to be featured in the personalized follow-up document 44D may be used. Statistical data correlating demographic characteristics to purchasing preferences may be used to predict one or more items of inventory as likely preferences for the potential customer. Such demographic characteristics may include, for example, age, occupation, gender, income bracket, race, religion, sexual orientation, or any other demographic that may serve as a basis of a statistical correlation with purchasing preference. Another method for selecting inventory items to be featured in a personalized follow-up document 44D is to simply select an inventory item 50 that may be the subject of an ongoing or upcoming promotion.

Additionally, any combination of the methods described to select one or more inventory items to be featured in a personalized follow-up document may be used. For example, information corresponding to an inventory item of actual interest and also an inventory item that is the subject of a promotion may be provided. As another example, information corresponding to an inventory item selected in conformity with a demographic characteristic and also information corresponding to an inventory item that is the subject of a promotion may be provided. As yet another example, information corresponding inventory items that are of actual interest, that are the subject of a promotion, and also that are selected in conformity with a demographic characteristic may be provided.

Furthermore, one or more of the inventory items 50 to be featured in a personalized follow-up document 44D may be selected by algorithms that use one or more of the above selection techniques. For example, a inventory item that correlates to statistical preference of three demographic categories of the potential customer may be selected over an inventory item that only correlates to a statistical preference of two demographic categories of the potential customer. As another example, an inventory item of actual preference to a potential customer that is also the subject of a promotion may be selected over another inventory item of stated interest to a potential customer that is not the subject of a promotion.

Additionally, multiple follow-up documents 44D may be sent to each customer lead 84. Each of the multiple follow-up documents 44D may feature information corresponding to the same or different inventory items 50 as the other follow-up documents, as may be determined by any of the methods discussed above. The decision to generate each follow-up document 44D may be determined individually, such as when salespersons or marketing personnel may determine another follow-up document is desirable. Alternatively, an automated process may be employed to send follow-up documents according to a pre-arranged schedule, such as one day, three days, one week, and one month after a contact with the customer lead. Either method may employ a process to determine a preferred ending to the sending of follow-up documents, such as when a predetermined number of such documents have been sent without any positive feedback from the potential customer, or when a predetermined amount of time has elapsed since the most recent contact with the potential customer, or when the potential customer requests to not receive any further follow-up documents.

It should be noted that additional benefits may be obtained by providing personalized follow-up documents 44D for customer leads 84. Such documents may provide return areas (not shown) for the potential customer to reply to requests for information, such as a customer satisfaction survey, or a request for one or more reasons why the potential customer did not or has not completed a purchase. Preferably, such documents soliciting feedback are prepared with prepaid postage, which may preferably be provided by the variable data printing method in conjunction with an electronic postage software application, or alternatively with manually affixed return postage.

Follow-Up Documents for Purchasers

In accordance with another embodiment of the present invention, the business method of using different and variable business data for various and separate business uses is used to generate follow-up documents for prior customers. As depicted in FIG. 8A, at least one collection of business data 38E includes values corresponding to prior customers 88. The step of selecting is preformed by selecting at least one of the prior customers 88. The printing produces a personalized follow-up document 44E for mailing to each of the selected prior customers where each follow-up document 44E has information 40E corresponding to a different one of the selected prior customers.

Several benefits may be obtained by sending personalized follow-up documents 44E to prior customers. One benefit is that receipt of a pleasant personalized follow-up letter or postcard is likely to improve customer satisfaction and may result in increased customer loyalty, repeat business, or referrals of other potential customers. Another benefit is that additional products may be featured for sale to the prior purchaser, such as maintenance or replacement products for a product purchased by a prior customer. Another benefit is that additional services may be offered for sale by the seller or an affiliate of the seller.

One example of obtaining benefit by sending personalized documents to prior customers is illustrated by a car dealership that may be interested in re-acquiring a vehicle previously purchased by a prior customer 90, in order to add the previously-purchased vehicle to the dealership's inventory for resale. For example, a dealership may select prior customers 88 from a collection of business data 38E corresponding to prior customers based on when the prior customers' financing has been fulfilled so that the vehicles are owned outright by the customers. A personalized document 44E may be sent to each prior customer featuring an image (not shown) of the customer with the purchased vehicle and a message congratulating the repayment of the loan and further suggesting the owner trade in the vehicle and apply the value toward the purchase of a new vehicle.

Additionally, a dealership may desire to acquire vehicles for resale that correspond to a desired model, year, or mileage. The dealership may select prior customers 88 that have purchased vehicles 90 corresponding to a desired criteria and generate personalized documents suggesting a trade-in incentive or promotion. Furthermore, if a vehicle owner has a vehicle serviced by the dealership or its affiliates, the dealership may select owners having vehicles with abnormally low mileage, regular service history, or good condition for receipt of a personalized document 44E suggesting a trade-in or a trade-in value for each vehicle.

As another example of the potential benefits that may arise from maintaining a collection of business data 38E corresponding to prior customers, personalized documents 44E may be generated such as coupons for prior purchasers 88 to use with affiliated providers of goods or services. The affiliated providers may be national or international retailers, or more preferably, local businesses that satisfy requisite conditions such as amount of yearly sales and number of locations. The continual use of such coupons by prior customers may result in establishing purchasing habits by the customers and loyalty to the affiliated providers. Additionally, the prior customers may be treated as members of an exclusive group of prior purchasers, provided with an affiliation card that may contain a magnetic strip for verification of purchases or discount eligibility. Ultimately, equipped with a base of prior customers, about whom significant information may be known such as income, credit rating and purchasing tendencies, a provider of financial services such as a bank or credit union may leverage such information and customer loyalty to significant advantage. For example, credit cards, preferably featuring the discounts with affiliated businesses as offered in the coupons or affiliation card, may be provided to selected prior customers at a significantly lower cost per issued card than may be typical of typical credit card issuers relying on mass marketing to attract potential cardholders.

Referral Documents

Referring now to FIG. 8B, in accordance with another embodiment of the present invention, the business method of using different and variable business data for various and separate business uses is used to generate follow-up documents 44F for prior customers relating to a referral program 92. The method further includes providing a referral incentive program 92 for prior customers 88 to benefit by providing referrals, where each personalized follow-up document 44F further has information about the referral incentive program.

Preferably, the referral incentive program 92 is designed to entice prior customers with a sufficient incentive to provide information about other potential purchasers, such as names and addresses of family or friends that may be interested in purchasing from the referral program provider or an affiliate. Examples of incentives include, but are not limited to, discounts offered by the program provider or affiliates, monetary awards, actual products or services, or entry in a give-away program such as a lottery for one or more featured inventory items.

For example, a car dealership may provide a prior purchaser 88 with a personalized follow-up document 44F introducing the prior customer to a referral incentive program 92. The prior customer may be encouraged to provide referrals in exchange for entries for a drawing to win a vehicle. The referral incentive program 92 may structured so that the number of entries 94 allocated to a prior customer 88 depends on the number and quality of referrals provided. For example, a prior customer may receive a single entry for each referral provided, and multiple entries for each referral if a designated number of referrals is provided. A prior customer may receive an even greater number of entries if one or more provided referrals results in an actual purchase. The drawing may be held at the dealership in a festive environment and may require the physical attendance of participants to win, further establishing customer loyalty, goodwill, and offering the dealership the opportunity to promote new vehicles and services.

A prior customer may receive multiple personalized follow-up documents 44F encouraging participation in a referral program 92. Examples of personalized information that may be provided in the personalized follow-up documents includes images or information corresponding to a prize or incentive for providing referrals, images of the prior customer or the inventory item that was purchased by the prior customer, and information informing the prior customer of the prior customer's status or standing in the referral incentive program.

Continuing the previous example, personalized follow-up documents 44F may be generated periodically showing both an image of the prior customer with the vehicle previously purchased and also an image and information corresponding to a vehicle that will be given away to the winner of the drawing. The number of entries 94 for the drawing that the prior customer has qualified for may be provided, as well as information on how many other referrals would be required to qualify for additional entries. For example, if the referral incentive program provides a single drawing entry for the first five referrals, but double entries for each referral if six or more are provided, a prior customer that has provided four referrals and hence having four entries for the drawing may receive personalized information such as that by providing two additional referrals, the prior customer would receive twelve entries, thereby tripling his or her chances or winning the drawing as a result of the two additional referrals.

Virtual Mall

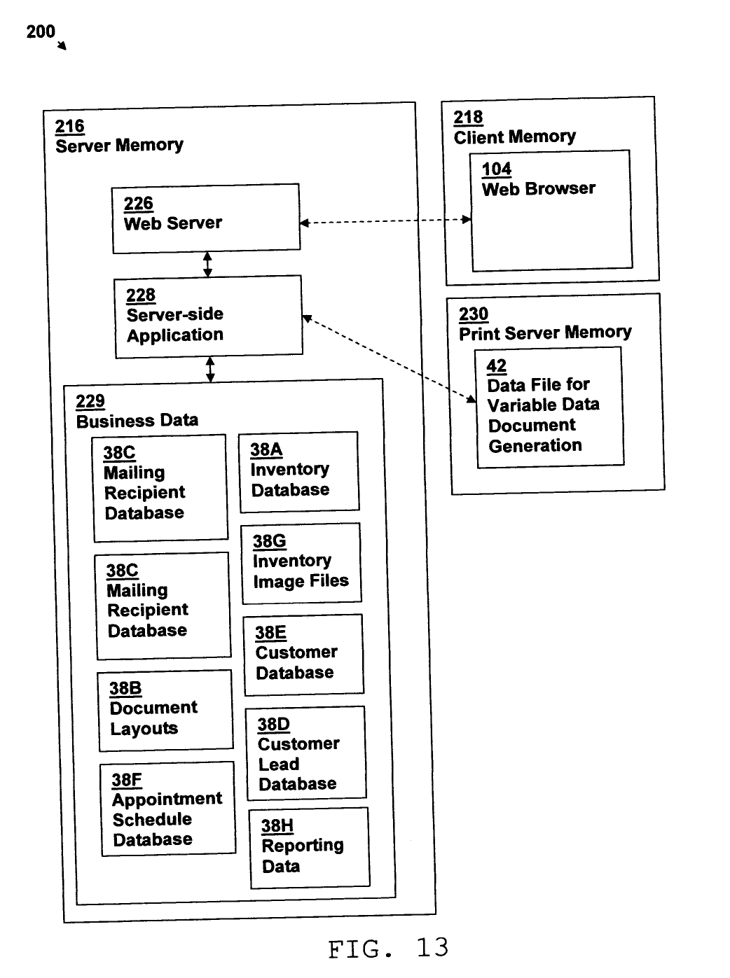

In accordance with another embodiment of the present invention, the business method of using different and variable business data for various and separate business uses is used with an internet marketing system and further includes providing at least one business 96 (FIG. 9), each business 96 having an inventory of items for sale and a sales staff 98. A first collection of business data 38A corresponds to inventory items, a second collection of business data 38B corresponds to customer leads, and a third collection of business data 38C corresponds to mailing recipients. The step of selecting includes selecting at least one mailing recipient. The step of printing generates at least one personalized document 44G for each selected mail recipient 40C, with each personalized document 44G having information corresponding to a different one of the selected mail recipients 40C. The method further includes providing a website 100 displaying information corresponding to a set of the inventory items 40A and displaying contact information for a potential customer to initiate communication. The step of printing generates at least one personalized document 44G for each selected mail recipient 40C, and each personalized document 44G further has information corresponding to an address 102 of the website 100.

The business method further includes acquiring new customer lead information in response to receiving a communication from the potential customer, where the new customer lead information includes at least one inventory item of interest to the potential customer, selecting at least one of the at least one business 96 having the inventory item of interest to the potential customer, generating an appointment for the potential customer to visit at least one member of a sales staff of the selected business, and providing the selected business 96 with the new customer lead information and the appointment information.

As depicted schematically in FIG. 9, several businesses 96, 96A, 96B each have a collection of business data 40A corresponding to inventory items. Inventory items from the individual businesses are promoted in a marketing website 100 accessible to the general public via the internet and viewable with a web browser 104. The inventory items promoted in the marketing website are each displayed with an image 54A-D of the inventory item and additional information 106A-D associated with the inventory item. Preferably, no indication is provided to distinguish is which of the contributing businesses 96, 96A, 96B is the source of the inventory items.

The marketing website 100 preferably provides user input areas 108-108B and controls 110-110B allowing a visitor to the marketing website 100 to determine a method for displaying inventory items. Some examples include, but are not limited to, sorting by type, price, size, color, or any other pertinent or desired feature of the inventory items. Preferably, the marketing website 100 has a shopping cart function, allowing visitors to engage one or more controls 112 corresponding to each inventory item of interest in order to add an inventory item to a list of such selected inventory items.

The website may feature one or more controls 114 to allow the visitor to display only such selected items for comparison or to edit the list of selected items. One purpose for displaying only selected items may be to display additional information on the inventory items a viewer is interested in, to the exclusion of inventory items the viewer has determined not to be of interest. Information about selected items may be enhanced to display additional, larger, or higher-resolution images of the inventory items, and additional textual information may be provided for a more thorough description of the selected inventory items.

The marketing website provides at least one method for a website visitor initiating a communication about inventory items of interest. Such methods may be the presentation of a telephone contact number 116, a fax number, or an email address. The website may further have one or more controls 118 enabling a visitor to submit a request for information about selected inventory items. The submitted request for information preferably automatically provides information on selected inventory items. Additional information that may be captured and transmitted in a request for information includes information provided by a visitor, such as a name, address, phone number, fax number, email address, marital status, income, social security number, or any other information a visitor may be willing to provide. In addition, the website may record and transmit information not directly provided by a visitor, such as information that may be acquired through standard web techniques including but not limited to a personal profile of a visitor, the operating system, the location, and the IP address of a computer used by a visitor to access the website. Data that may be recorded includes any and all interactions with the website 100, such as searches preformed, items selected and later removed, comparisons preformed between inventory items, length of time spent at the website 100, and length of time viewing individual inventory items. Further information may be obtained through well-known techniques involving cookies (small files on a visitor's computer that may be accessed by an internet server); for example, the number of prior visits to the site, or an identifying user code, password, or other information. Additional information may be obtained by accessing cookies pertaining to interactions with affiliates' or competitors' websites.

Because a website visitor initiating a communication corresponds to a potential customer expressing actual interest in items of inventory, any or all information that may be collected may prove valuable toward a completion of a sales transaction and may be recorded as customer lead information. Preferably, a communication initiated by a visitor to the marketing website is responded to immediately or as soon as possible. Methods of receipt and response to a communication include but are not limited answering a telephone call, receiving and returning a fax or email, or processing a request for information submitted via a control on the website. The method of response to a communication initiated by a visitor to the website need not mirror the method of initial communication. As one example, an email from a visitor may be responded to with a phone call.

Preferably, a staff of trained personnel is provided to facilitate such communications. An actual or virtual “call center” may be provided to facilitate receipt of and the return of communications. The call center may consist of a staff equipped with telephones, one or more computer capable of sending and receiving electronic communications such as email, facsimile machines, and any other equipment desirable to engage in inward- and outward-bound communications. Such a staff of trained personnel may comprise one or more people in a single location, or may comprise people in multiple locations, such as may be preferable for business efficiency, for example, or to promote the satisfaction of a visitor to the website. For example, multiple staffs of personnel may be located in various geographic locations so that a potential customer, which may be a website visitor or mailing recipient, may communicate with a representative having similar regional characteristics as the website visitor or mailing recipient, such as spoken accent, cultural values, familiarity with local sports teams or events, or time zone correlation.

Automated techniques may be applied to some or all communications initiated by a potential customer. For example, a telephone call may lead a caller to an automated menu allowing the caller to provide information and receive information without human intervention, or with minimal or optional human intervention, using well-known techniques. Other automated techniques may be used, such as automatically obtaining an incoming call's phone number, allowing a determination of additional information such as a location of the call's origin and the name of a person registered to the phone number from which the call is initiated. Information so acquired may be provided to a person answering the call for use during the conversation or for recordation in a collection of business data corresponding to customer leads.

Other examples of using automated techniques include, but are not limited to, a sequence of steps preformed in response to a request for information executed via a control on the marketing website. Any or all of the steps of recording captured customer lead information, selecting one or more businesses 96 having the inventory items of interest to a potential customer, generating an appointment for a potential customer to visit at least one member of a sales staff 98 of the selected business or businesses, and providing a selected business with customer lead information 84 and appointment information, as well as providing a potential customer with information corresponding to the one or more appointments with sales staff 98 of selected businesses, may be preformed automatically, such as by instructions preformed on a processor in accordance with a computer program.

One benefit of the present invention is that several businesses 96 may participate in providing inventory items to be featured on the website 100. The ‘virtual mall’ enables potential customers to view a larger selection of inventory items than would be available by the individual businesses alone. Potential customers may therefore conduct an internet search for desired items for purchase more efficiently by visiting the combined website 100 than by visiting several smaller websites.

Another benefit is the efficiency to participating businesses 96 in marketing their products. By providing a single source of personalized documents having the corresponding benefits already described, and providing a centralized service to receive communications and generate appointments to view inventory items of interest, duplicative marketing, staffing, and equipment costs for each of the participating businesses may be reduced or eliminated.

Yet another benefit arises from the collection of customer lead information 84. A collection 38D of customer lead information gathered from potential customers initiating communications after receiving a personalized document, or visiting the website, or otherwise, may be standardized and used in accordance with any or all of the methods previously described. Furthermore, if multiple businesses participate, a greater amount of data corresponding to customer leads may be obtained than by any of the businesses individually.

Yet another benefit arises from the ability to provide additional services to potential customers. For example, if the present method is used to promote inventory items of several car dealerships, additional services other than the display of inventory information may be provided via the website. Such services include, but are not limited to, a credit check or pre-qualification that may be preformed using information provided by a website visitor which is submitted electronically to a credit reporting agency such as Experian. Results from such a pre-qualification may be provided directly to the website visitor or may be used as a criterion for display of vehicles that the website visitor may realistically be able to purchase.

Other services that may be provided in applying the is present invention for car dealerships include information or promotional rates from insurance providers, lenders, and other vehicular-related services. A further service of particular relevance to car dealerships is the ability to provide information relating to a potential customer's potential trade-in. One method of performing such a service is to allow the potential customer to provide information via the website about a potential trade-in, such as a VIN, mileage, and amount owed on the vehicle. The VIN may be used to obtain further information about the vehicle electronically by a service such as Kelly Blue Book or CarFax. Alternatively, information may be provided solely by the potential customer. The information received may be used to provide a potential customer with an actual or approximate trade-in value that may be applied toward the purchase of a new vehicle. Alternatively, the exchange of information concerning a trade-in, or any other additional services, may be conducted via other communications other than via the website, such as in a telephone call or in response to an email or fax. The information relating to a trade-in, or any other service that may be offered, may be collected and stored in a collection of data corresponding to customer leads for later use with as described above or otherwise.

Virtual Mall with Niche Marketing

In accordance with another embodiment of the present invention, the business method of using different and variable business data for various and separate business uses is used with an internet marketing system where the selecting of the mailing recipients 40B is performed in conformity with at least one desired demographic characteristic, and the set of inventory items 40A displayed on the website 100 is chosen to conform to at least one of a preference and a purchase capacity typical of the demographic characteristic.

As an example, mailing recipients 40B selected for receipt of personalized documents 44G corresponding to a marketing website 100 promoting vehicle sales may be screened by credit rating or disposable income. Preferably, this is performed by an arrangement with an institution such as a credit union or bank having such information on a large number of the institution's members or customers. The institution may then provide pertinent information corresponding to potential recipients of personalized documents having information about the internet marketing website. Preferably, the institution may allow automated access to customer or member information from the marketing website to allow selection of inventory items that represent a price range that may be easily afforded by a potential customer. If such an institution provides financing for vehicular purchases, a potential vehicle purchaser may benefit from preferential financing terms due to the potential purchaser's existing relationship to the institution. The institution may also benefit by providing an increased amount of vehicle loans.

Further, because of customer loyalty or trust for the institution encouraging visitors to the marketing website, preferential financing for purchasers, and the ability to match inventory items with actual purchasing power, sales efficiency is likely increased at the marketing website. Such increased efficiency may be measured by percentage of mailing recipients that visit the marketing website, percentage of website visitors that initiate communications concerning an item of interest, percentage of interested potential purchasers that qualify for financing for a desired inventory item, number or value of actual sales per mailing recipient or website visitor, or any other pertinent metric. Such increased sales efficiency may allow inventory items to be offered at discounted prices while maintaining or increasing total profitability, providing further motivation for potential purchasers and also motivation for an institution to provide access to member or customer information in order to build or maintain loyalty, as well as increase lending activity.

As another example, selected mailing recipients 40B for a marketing website 100 may be selected in accordance with bankruptcy filings. Items of inventory 40A selected for promotion on the marketing website may be selected to be affordable to persons having poor credit. Additional benefits may be obtained by providing access to high-risk lenders from the marketing website 100 to maximize the efficiency of the sales process.

Other demographic characteristics that may be used for the selection of mailing recipients and corresponding inventory items include, but are not limited to, gender, age, sexual orientation, religion, geographic location, home ownership or recent home purchase, and affiliation with professional or social organizations.

It should be clearly understood that unless otherwise specified, all examples provided are to be considered illustrative of the possibilities offered by the present invention and should not be considered limiting. For example, although many of the examples illustrate applications of the present invention by a automobile dealership, it should be clearly understood that the present invention may be applied to provide substantial benefit to any type of business, offering any type of product or service ranging from the expensive, for example: timeshares, jewelry, aircraft, personal and commercial electronic equipment, and artwork; to the inexpensive, for example: grocery products and pet supplies, school products and dry-cleaning services.

Software and Systems

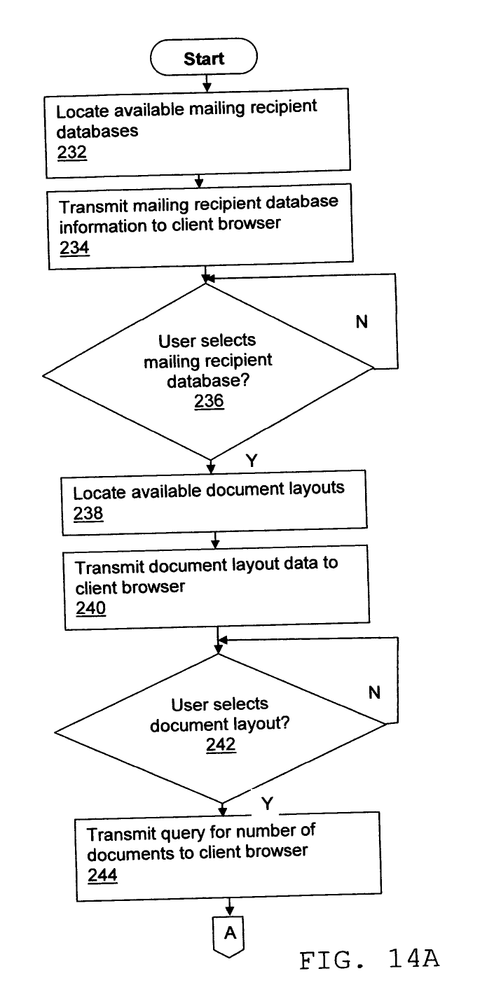

Referring now to FIG. 10, a computer network system 200 for supporting various business operations in accordance with an embodiment of the present invention is depicted in a block diagram. A variable data digital press system 24 provides for generating variable data documents 44. A server 202 provides for storage and retrieval of business information and exchange of information via the network system 200 to the variable data digital press system 206 for the production of variable data documents 44. The server 202 further performs operations upon business data 216 (FIG. 13) in support of business operations. The server 202 is coupled to the Internet 214 and functions as a web server for providing one or more websites in support of business operations. Although a single server 202 is depicted in FIG. 1, a system of multiple servers 202 may be used to increase system efficiency, provide security, compartmentalize system functions, and provide failover capability.

Client computers 204-204C are coupled via the network system 200 to the server 202 for providing users access to business data 216 and variable data digital press document production capability. The networked client computers 204-204C may be coupled via a public network such as the Internet 214 or may be coupled via a private network such as the various “intra-nets” that are implemented within corporate offices and other installations requiring secure data communications.

Because in a preferred embodiment the client interaction with the server is restricted to browser-based communications via the web server program, the client computers 204-204D are preferably thin clients having a minimum of components sufficient to engage in network communications, support an input device and a graphical display, and execute a browser program of the type in general use for interaction with the network system server. The preferred use of thin clients provides several benefits over traditional personal computers that are more expensive, require more maintenance, and whose enhanced capabilities encourage users to engage in activities such as enjoying multimedia content and installing and executing non-business computer applications such as computer games. However, it should be understood that client computers 204-204D may be any type of computing device capable of executing a browser program and accessing the network system via a network connection or the Internet.

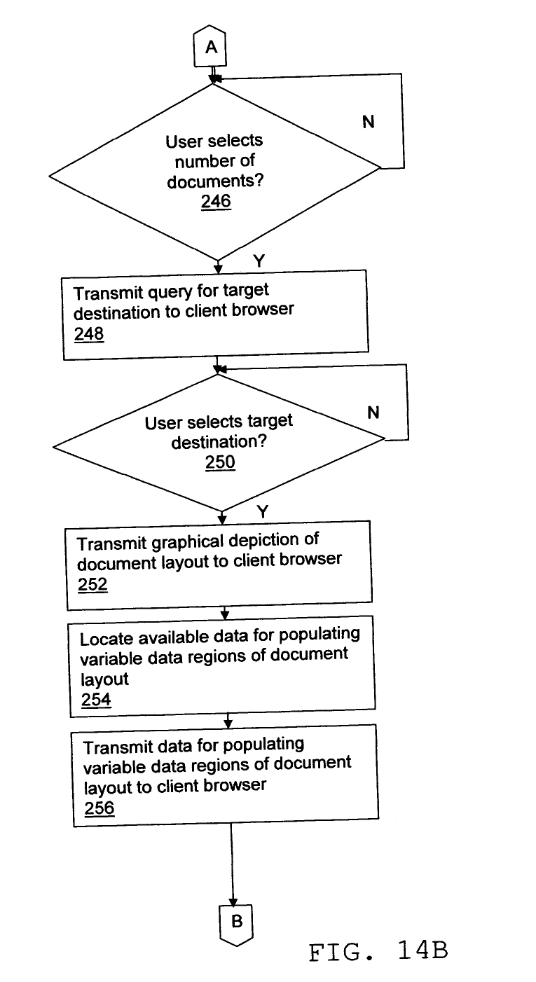

A digital camera 56 for acquiring digital images and a portable data entry device 208 are coupled to the network system for capturing and downloading or retrieving information about inventory items. As depicted in FIG. 11, the portable data entry device 208 has a memory 216A, a processor 218A, a graphical display 222, an input device 224, such as a keyboard or a scanner or both, and a wireless interface 220. Preferably, the portable device 208 is a personal digital assistant (PDA) capable of executing a browser program or other application dedicated capturing pertinent inventory information, but may be any portable device such as a tablet computer, laptop or notebook computer, or Internet-enabled cellular phone or is pager. Because inventory items may exist at various locations, it is preferred that at least one or both the digital camera 56 and the portable data entry device 208 are wirelessly coupled to the network system via a wireless interface 220 with the server 202 for data transfer to and from the remote location. Preferably, the digital camera 56 is physically coupled to the portable data entry device 208 that supports wireless communications, allowing a user to acquire digital images of an item of inventory, transfer the digital images to the tablet computer, manually input information corresponding to the inventory item, and wirelessly transfer the images and entered data to the server.

It should be noted that the digital camera 56 and portable data entry device 208 may be integrated into a single device. For example, devices such as computers, cellular phones or PDAs often feature digital cameras and Internet capability. However, the camera used in the present embodiment should be able to capture images of sufficient quality for use in marketing or sales efforts; currently, the relatively poor resolution of commonly-available integrated cameras prohibits such a use. Further, the camera 56 or portable device 208 should have sufficient memory to store multiple high-resolution images of multiple inventory items prior to transferring images to the server 202 when wireless communications are not available or desirable.

Further, the portable device 208 may be used to retrieve information from the server 202. For example, a user may input inventory identification information such as a stock number or VIN into the portable device 208 to retrieve detailed information about the inventory item at a remote location from the server 202.

Referring now to FIG. 12, details of a computer network system 200 in accordance with another, simplified embodiment are shown. A server system 202 includes a server processor 218 for executing program instructions coupled to a server memory 216 containing data and server program instructions embodying methods of the present invention. The server processor 218 is also coupled to a network interface (not shown) for connection via a network connection to a variable data digital press system 24 and to a wireless interface 220 for connection via a wireless connection to a client computer system 204D-E. The server program instructions include instructions for supporting the wireless interface 220 for connection to the client computer system 204D-E and further for connection to the variable data digital print system 24 via a wired local area network (LAN) connection provided by the network interface.

The variable data press system 24 includes a print server 10 coupled to a variable data digital press 26. The print server 10 receives information corresponding to a request for a generation of variable data documents 44 from the server 202 via the LAN connection. The print server 10 provides instructions to the variable data digital press 26 to generate the requested variable data documents 44.

The client computer system 204D-E includes a client memory 216B-C containing data and client program instructions coupled to a client processor 218B-C for executing the client program instructions. The client processor 218B-C is also coupled to a graphical display device 222B-C and at least one input device 224A-B. The client program instructions include instructions for executing a browser program as well as supporting communications with the server 202.

The above-described computer network system 200 is exemplary only and should not be construed as limiting the scope of the present invention. For example, although the connection between the server 202 and the variable data digital press system 24 is depicted as a LAN connection, it is may instead be any connection capable of transmitting data between the server 202 and the variable data digital press system 24. Similarly, although the connection between the client computer system 204C-D and the server 202 is shown as a LAN or Internet 214 connection, it may instead be a wireless connection or any other connection capable of transmitting data between the client computer system 204C-D and the server 202. In addition, benefits may be obtained by the variable data digital press system 24 including multiple variable data digital presses 26 for greater production capability, and any number of print servers 10. Alternatively, no print server 10 may be desired at all, for example, if the server system 202 contains program instructions for duplicating the functions of the print server 10. In such a case, the server 202 may be coupled directly to the variable data digital press or presses 26.

Referring now to FIG. 13, the organization of computer programs implementing methods of the present invention are depicted in a block diagram. Server memory 216 contains a web server program 226 that pushes information to and receives information from a browser program 104 contained in client memory 218 in conformity with server-side application 228. Server-side application 228 interacts with business data 216 stored in server memory that includes databases 38A-H containing information corresponding to mailing recipients, inventory, customers, customer leads, appointment schedules, and document layouts, as well as files containing digital images of inventory. The server-side application 228 also generates data files 42 for the generation of variable data documents 44 and transmits the data files 42 into the memory 230 of the print server 10.

Variable Data Document Generation

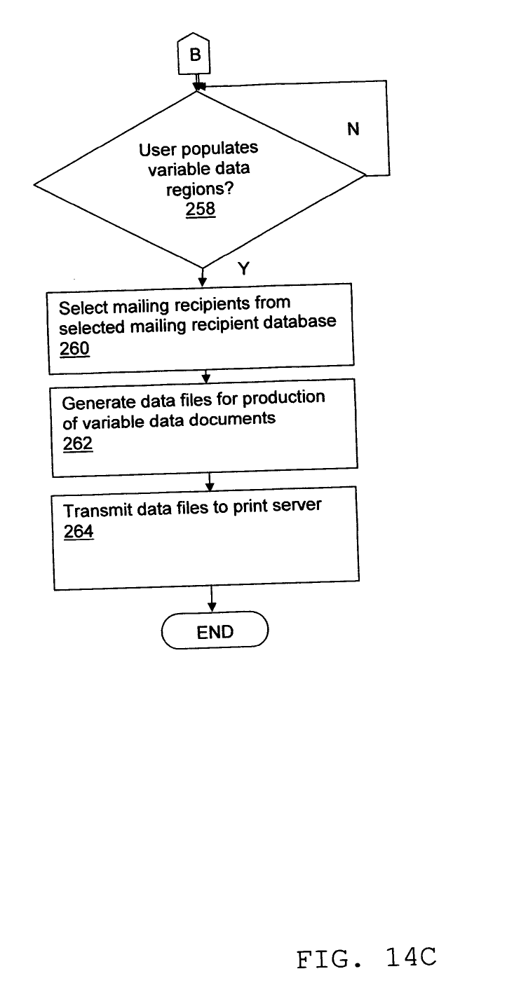

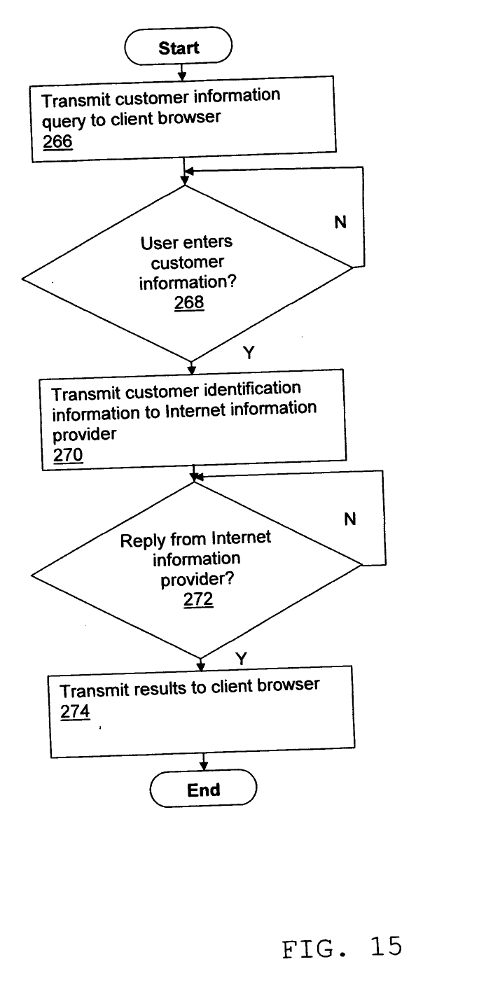

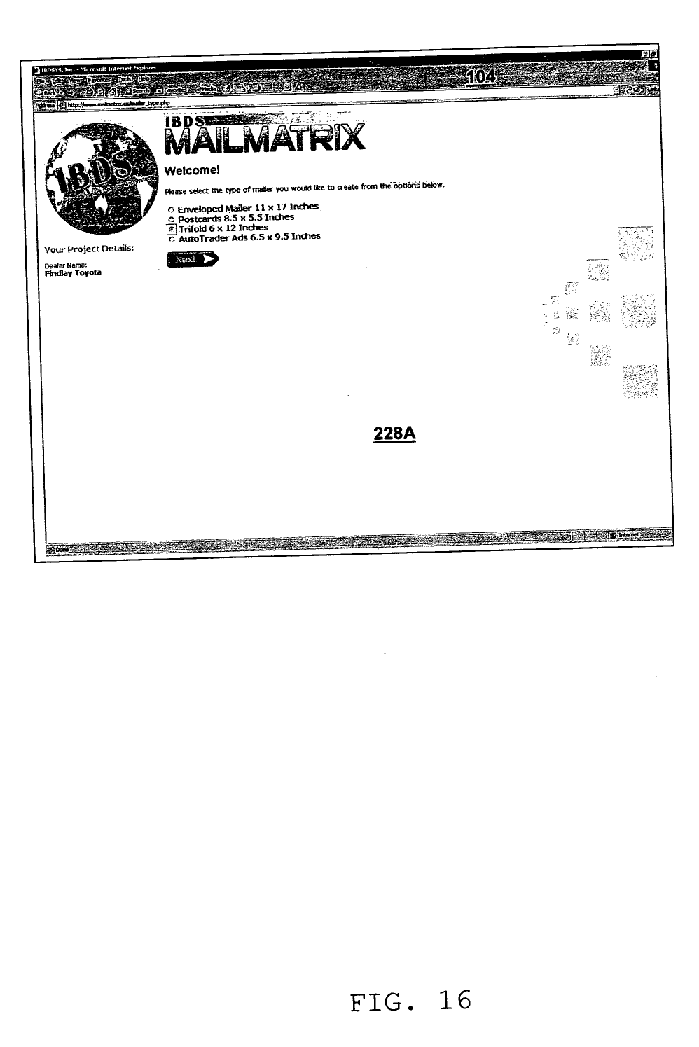

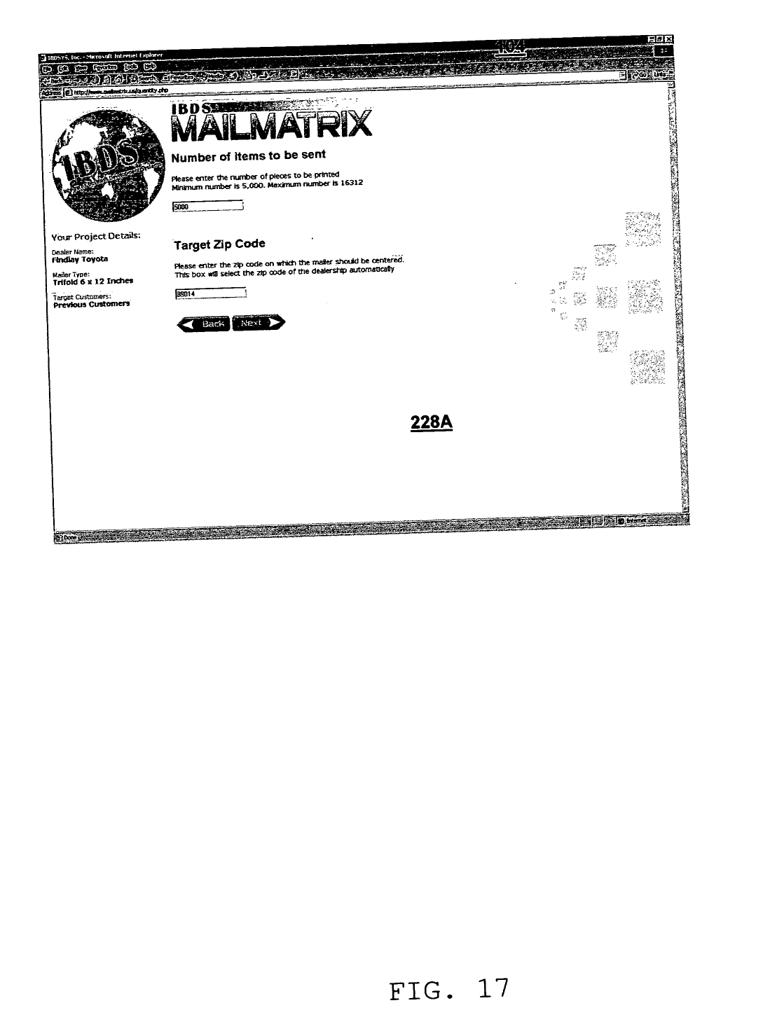

Referring now to FIGS. 14A, 14B, and 14C, an operation of the system of the present invention in accordance with a method of the present invention is depicted in a flowchart. A user initiates the method by directing a browser program executing on a client computer 218 to a URL initiating a variable data document production application 228A on the server 202. As depicted in FIG. 16A, the server application 228A locates databases of mailing recipients 38C available for use with the selected document layouts (step 232). Information corresponding to the databases of mailing recipients is transmitted to the client browser for selection by the user (step 234). The information corresponding to the available mailing recipient databases may consist of database names or descriptions of pertinent characteristics of the content of the databases, such as recipients that have recently filed for bankruptcy, or recently purchased a house, or sharing a particular demographic characteristic.

After the user's selection of one or more database of mailing recipients (decision 236), the server application 228A locates within the server memory document layouts available for use with the selected databases of mailing recipients (step 238) and transmits information to the client browser corresponding to the available document layouts (step 240). The transmitted information preferably contains graphical depictions of the document layouts, but may comprise other information such as names or descriptions of the document layouts.

After the user's selection one or more document layouts is received by the server application 228A (decision 242), the server application transmits to the client browser queries of the number of documents to be generated (step 244, decision 246) and one or more target destinations of the documents (step 248, decision 250), depicted in FIG. 17. The target destination will function as the geographic center for the mailing recipients, who will be determined by proximity to the target destination.

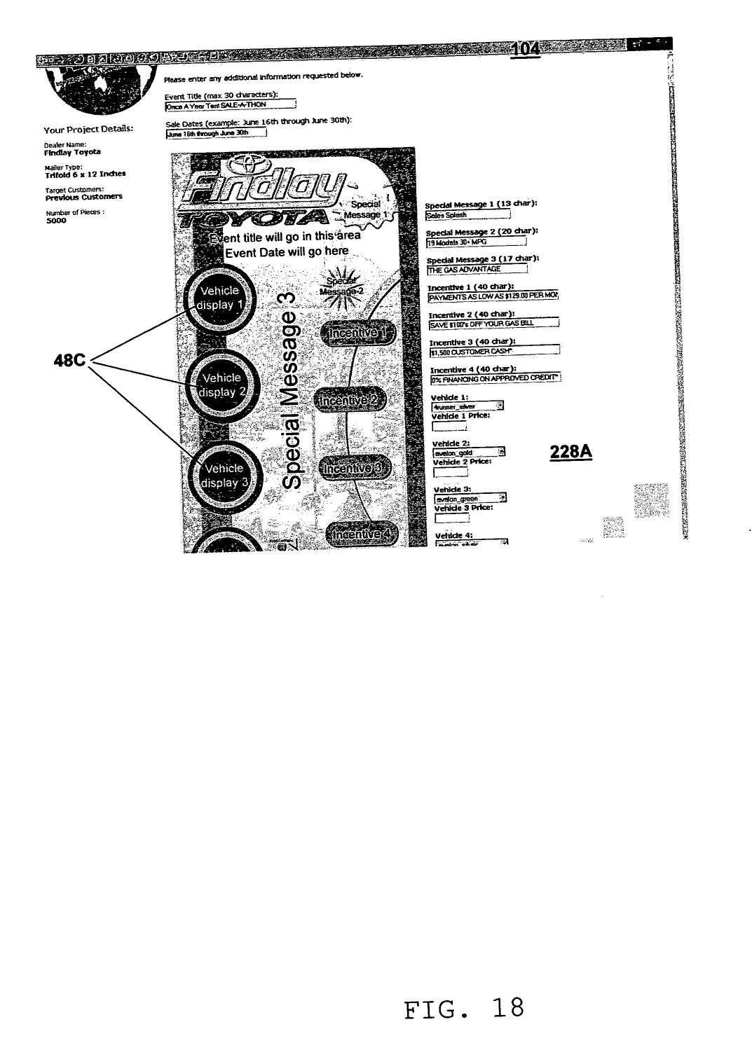

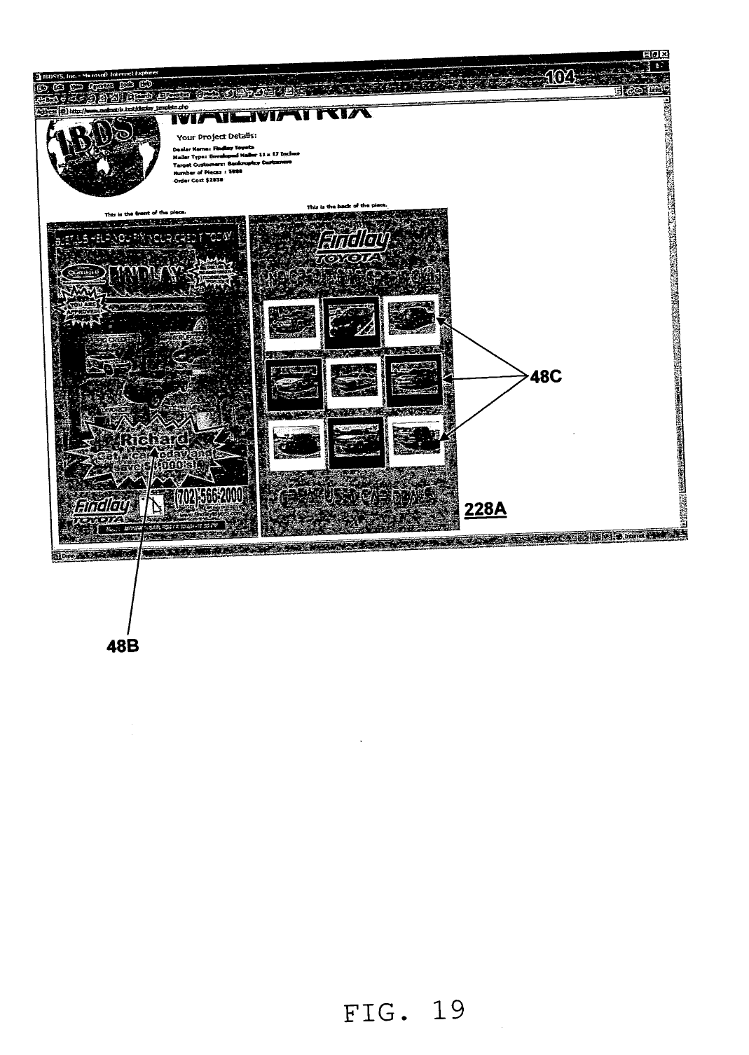

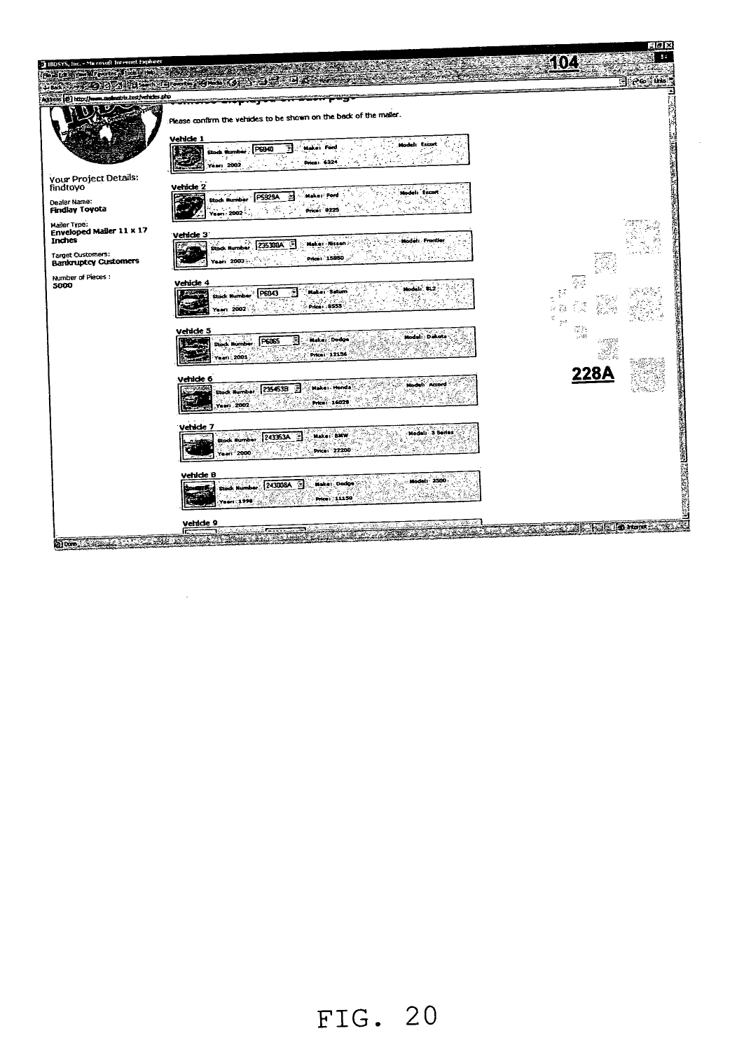

After the user's response to the number of documents to be generated and the target destination is received by the server application, the server application next transmits to the client browser instructions for graphically depicting one of the selected document layouts (step 252). As depicted in FIGS. 18 and 19, the client browser displays a graphical depiction of a document layout containing static information and one or more variable data regions 48C.

The server application 228A locates within the server memory 216 data available to populate the variable data regions (step 252). For example, the document layouts depicted in FIG. 5B and also in FIG. 19 contain a variable data region 48B corresponding to a salutation. This variable data region may be populated by a selection of data fields of the selected mailing recipient database 38C; for example, if the selected mailing recipient database 38C has data fields TITLE containing titles, FIRSTNAME containing first names, and LASTNAME containing last names, TITLE and LASTNAME may be selected so that each document 44 will contain the recipient's title and last name, such as “Dr. Smith” or “Mrs. Jones.” Alternatively, FIRSTNAME alone may be chosen so that each document 44 will contain only the recipient's first name, such as “Bob” or “Mary.” Similarly, the variable data regions 48 may be populated by other information such as data corresponding to inventory descriptions or digital images of inventory items.

Once located, the server application transmits to the client browser program the information for populating the variable data regions (step 252) so that the user may select which data should populate which fields, depicted in FIG. 20. Preferably, the server application 228A provides information to the client browser 104 allowing the client browser user to graphically view the available information such as inventory images and to select using graphical interface techniques such as drag-and-drop to populate the variable data fields. This functionality may be provided by the server application using the PHP programming language invoking SQL operations on databases and server memory.

When the user has completed the population of the variable data regions of the documents to be created (decision 258), in addition to any other modifications or static information the user may have added to the document layout, the information is then transmitted back to the server application 228A. The server application 228A generates data files to send to the print server in response to the selections the user has made (step 262).

The server application 228A selects mailing recipients by selecting mailing recipients having addresses located within a small radius of each target destination, and increasing the radius until enough mailing recipients have been selected to satisfy the requested number of documents to be generated (step 260). For each selected recipient, the server application locates the data to be included in each variable data region 48 of the document layout and adds the data to the data files for the print server. Additional information for the data files includes formatting information such as number of documents per sheet, the format of each sheet, and background images to be used in the documents. If digital images are to be included in the documents, the image file names or file paths may be included in the data files.

The server application then transmits the completed data files to the print server (step 264), which interprets the data files and instructs the variable data digital press to generate the requested variable data documents.

The above description is meant to be illustrative and not limiting. For example, although the above steps are described sequentially, they may be preformed in any order that permits the user of the client computer system to designate document layouts, determine mailing recipients, and select business data to populate static and variable data regions for printing of variable data documents.

Referring now to FIG. 15, a preferred operation of the system of the present invention in accordance with a method of the present invention is depicted in a flowchart. In order to expedite a transaction such as a purchase of an inventory item in which financing may be required by the purchaser, a pre-qualification may be preformed based on the customer credit and price of the desired inventory item.

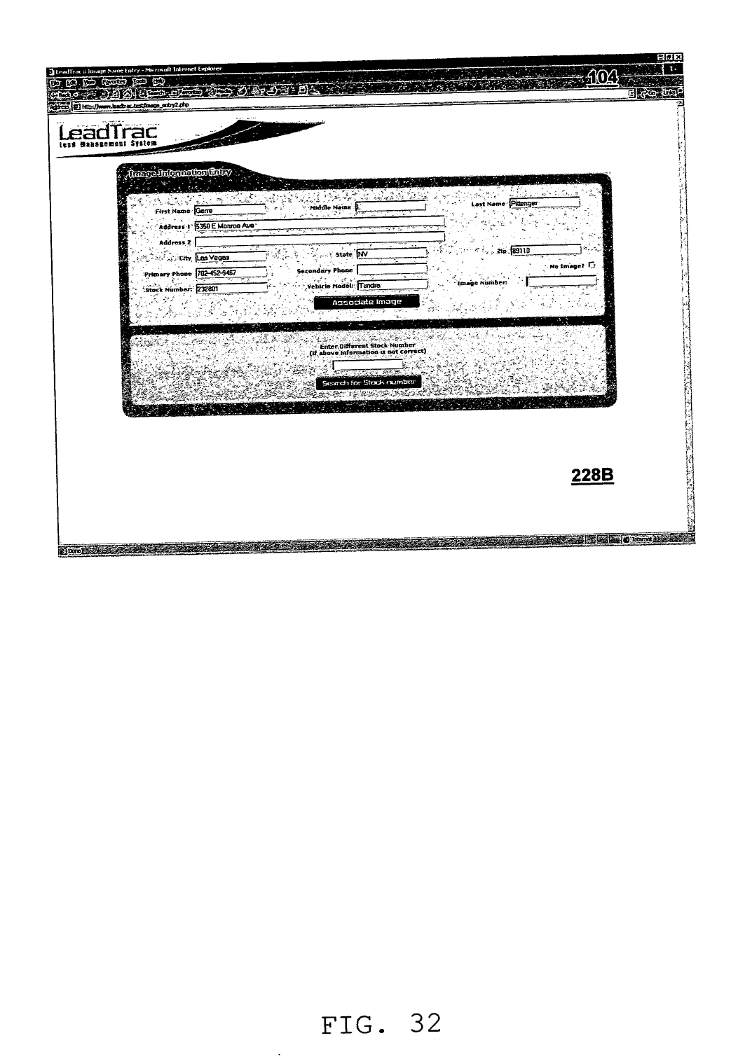

A user of a client computer 204 initiates the operation of the system by directing a browser program 104 executing on a client computer 204 to a URL initiating a transaction support application 228B on the server 202 of the present system via the Internet. The client user may be a potential customer interacting with a marketing website that launches the transaction support application in response to the potential customer's request for pre-qualification information, or for electronic financing application review for lender approval, which may require the potential customer to have selected a specific inventory item that is desired to be purchased. Alternatively, as depicted in FIG. 31, the client user may be a representative of the seller desiring to complete a transaction with a potential purchaser, launching the transaction support application 228B independently or in conjunction with other transaction management programs, websites, or systems.

The server memory 216 contains business data 229 including data corresponding to inventory items 38A and data corresponding to customers 38E. The server 202 transmits to the browser program 104 on the client computer 204 prompts for a user of the client computer 204 to input customer identification information (step 266). The customer identification information preferably contains information required for a determination of credit history or status, such as name, address, and social security number. After entry of customer identification information (decision 268), the information is transmitted to the server 202 via the web server program 226. Preferably, to help protect privacy, all transmissions containing customer identification information are secured using standard methods such as encryption.

The transaction support application 228B then transmits the customer identification information to an Internet information provider for querying at least one of customer credit information and financing approval information (step 270). For pre-qualification, the customer identification information alone may be transmitted to a credit rating agency such as Experian that supports electronic credit reporting. For financing approval, information corresponding to a desired inventory item may also be transmitted so the lending institution may determine if financing should be provided.

After receiving a reply transmission from the Internet information provider (decision 272), such as credit information or approval or denial of financing from a lender, possibly specifying financing terms such as interest rate, the information is formatted to be viewed on the client computer's browser program 104 and transmitted to the client computer 204 (step 274). Additionally, some or all information regarding the customer and query to the Internet information is preferably stored as business data 229 in the server memory 216 for later use. As an example of such later use, personalized documents 44 may be produced in accordance with methods of the present invention for delivery to customers whose pre-qualification or financing prevented purchase of a desired inventory item, featuring a more affordable inventory item at an attractive price for which that the potential customers may qualify for financing.

Software System Examples

Referring now to FIGS. 16-36, methods and systems in accordance with embodiments of the present invention are depicted as an example of a system supporting the operation of a car dealership. The system includes, as described previously and depicted in FIGS. 10-13, a server 202 having memory 216 storing business data 229 and program instructions including instructions for executing a web server program 226, an inventory management and Internet marketing program 228C, a transaction support program 228B, and a variable data document generation program 228A. The server 202 is coupled to client computers 204 via connection to the Internet 214, and to a print server 10 via a network connection, the print server 10 being further coupled to a variable data digital press 26.

In this particular example, the server 202 runs a Windows operating system executing Apache web server software. The business data 229 is stored either as independent files, such as for images or document layouts, or in relational databases administered by MySQL software. The inventory management and marketing program (WebTrac) 228C, transaction support program (LeadTrac) 228B, and variable data document generation program (MailMatrix) 228A are written in the PHP programming language for supporting database queries, file manipulation, and client interaction via a web browser 104 on a thin client system. All significant program execution is preformed by the server 202, without requiring client-side processing such as via Java applets, although minimal client-side functionality, such as data format verification, may be preformed within the client browser program via JavaScript instructions. Finally, the variable data digital press 26 of the current example is a Xerox DocuColor 6060 Digital Color Press capable of producing single- or dual-sided color variable data documents 44 on a large variety of substrate types, sizes and weights, and the print server is a CXP6000 Color Server using Creo technology. However, it should be clearly understood that the present invention may be practiced using any hardware or software capable of performing the required functions, such as commercially available computer, database, and server software systems from Sun Microsystems or IBM, for example, or variable data digital press from other providers such as the NexPress 560 from NexPress Solutions LLC.

At the core of the present system is MailMatrix 228A. MailMatrix 228A operates in response to receiving information corresponding to a document generation request, including: a document type, such as a postcard, tri-fold brochure, postcard, or 8½″×11″ document; a layout defining a document format, background imagery, static data fields, and variable data fields 48; data to populate the static data fields; and data or instructions for locating data to populate the variable data fields 48. Instructions for locating data to populate the variable data fields 48 may include a database name and database field name, designating a particular type of data for retrieval, and a set of database record keys indicating which records the data should be retrieved for.

Using the received information, MailMatrix 228A then generates a set of data files 42 for transmission to the print server 10. Preferably, the data files 42 include a .dbm file defining a master layout page, including information corresponding to physical page definition, logical page definition, and VIP commands for processing variable data layout, such as locations for insertion of data, instruction looping logic, and conditional language for data selection and data formatting, such as image cropping, rotation, or resizing. The data files 42 also preferably include a .dbf file containing print server commands such as a project file path for locating resources, designating the .dbm file associated with the project, designating a .jdt file functioning as a function library or definition file for logical page formatting and fonts.

The .dbf file also includes data to populate each variable data region 48 on each document 44 to be produced. The variable data is acquired by MailMatrix 228A through queries made to designated databases in server memory 216, such as customer lead 38D, mailing recipient 38C, and inventory databases 38A. In the event that the data to populate a variable data region is an image contained in a separate image file, the .dbf file contains a file name designating the image file to be used.

After generating the data files 42, MailMatrix 228A transmits the data files 42 and all supporting files to the print server 10. Supporting files include image files specified in the .dbf data file and may also include one or more image files for background images of the documents to be generated. Upon receiving the data files 42, the print server 10 initiates document production.

Although preferably the data files 42 and supporting files are physically transmitted to the print server 10, it should be understood that significant benefit may also be obtained by logically transmitting the files to the print server 10 via directory mapping. In this case, the print server 10 accesses the files as if they were physically present on the print server 10, while actually remaining on the system server 202 instead. However, whether the system server 202 physically transmits the data files 42 by pushing them to the print server 10, or logically transmits the data files 42 by placing them in a mapped directory for print server 10 access, the data files 42 are acted upon by the print server 10 processor and used to direct the variable data digital press 26 in the production of documents 44.

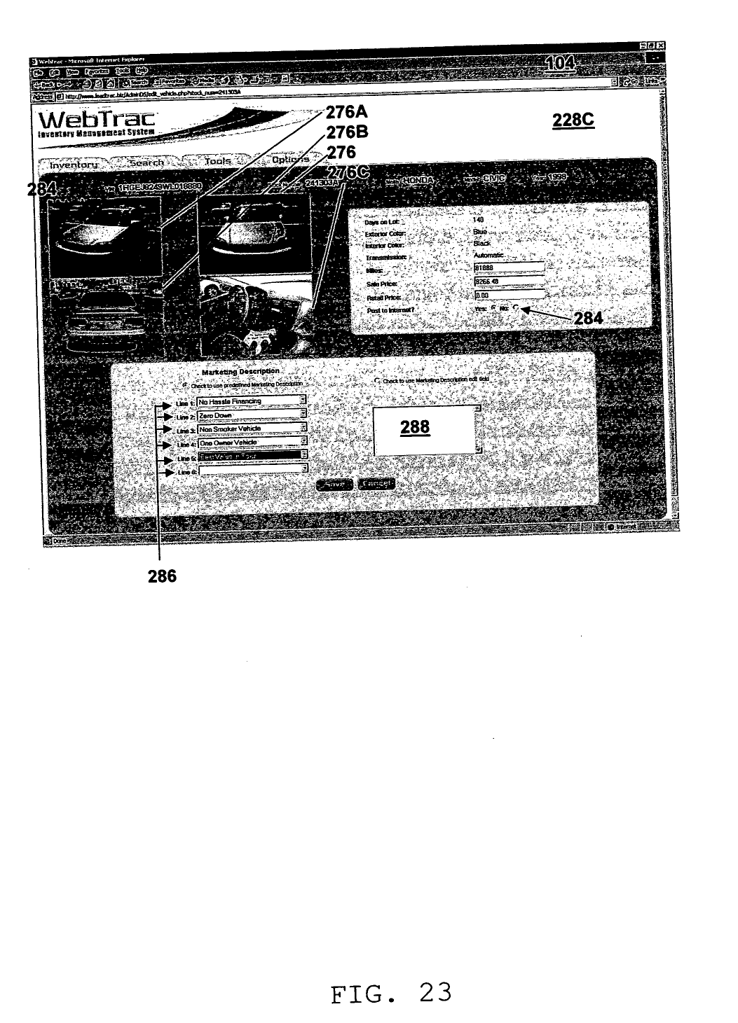

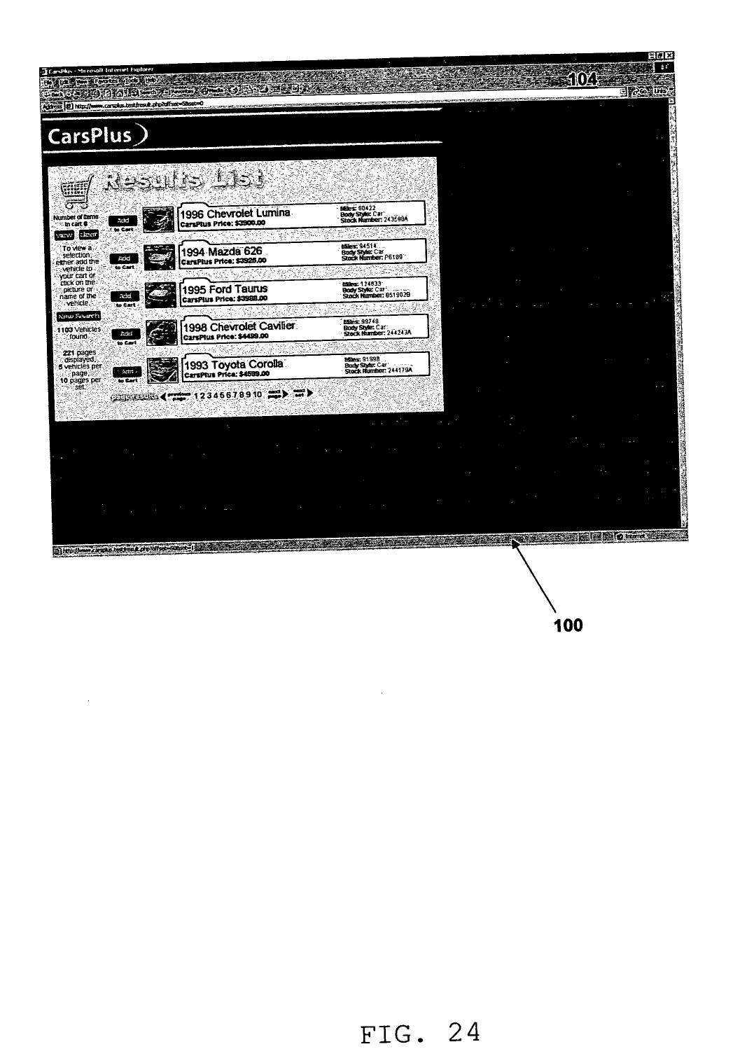

Information corresponding to inventory items, in this case vehicles 50 available for sale, is collected by one of at least two methods. Recently acquired inventory is collected by a dealership representative with a portable device 208 such as a tablet computer or PDA, a digital camera 56 coupled to the portable device 208, and a bar code scanner or image scanner 225 coupled to the portable device 208. The digital camera 56 is used to take high-resolution images of a newly-acquired vehicle 50 from a standard set of viewing angles, such as a front view 276, a rear view 276A, a partial side view 276B, and an interior view 276C (see FIG. 23). Image files stored by the digital camera 56 are automatically named in a manner designating the particular vehicle and the viewing angle.

If the vehicle 50 arrives with printed information such as a card or sticker having a bar code or text containing pertinent information, the bar code or image scanner 225 is used to capture the information. Likewise, an image scanner 225 may capture the VIN as provided by the manufacturer. Scanned information is interpreted either by the portable device 208 or later after being received by the server 202. Desired information that cannot be scanned is manually input by the representative using an input device 224 of the portable device 208.

The collected information is then transmitted to the server 202 via a wireless connection such as Bluetooth, or the portable device 202 may be physically connected to the network system 200 for download to the server 202 such as when there is a large amount of wireless communication preventing or slowing wireless transmission.

Using the VIN, the collected information is supplemented by an electronic query to Kelly Blue Book, either in the form of an Internet communication or via a database provided by Kelly Blue Book, so that the vehicle information includes the vehicle make, model, and model year, interior and exterior color, transmission type, mileage, retail price, VIN, and stock number. Additional information that is collected with the collected vehicle information includes an Internet sale price and the date of arrival on the inventory lot, as well as the dealership's cost for acquiring the vehicle. The vehicle information is then stored in a database of available inventory 38A.

A second method of acquiring vehicle information is to download data from a pre-existing database of vehicle information. As an example, when the present system is first introduced to support the business operations of an existing dealership, data on existing inventory may be recorded on a mainframe or legacy system. Also, when the dealership is part of a larger network of dealerships having a centralized inventory database, the centralized inventory database may be queried nightly to update or synchronize records with the inventory database of the present system.

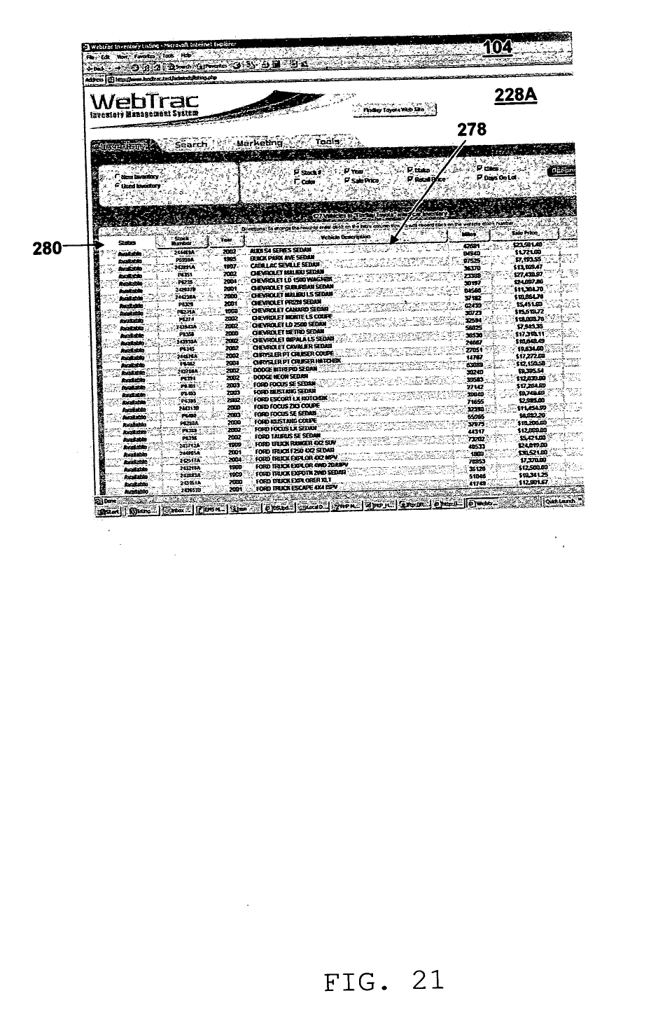

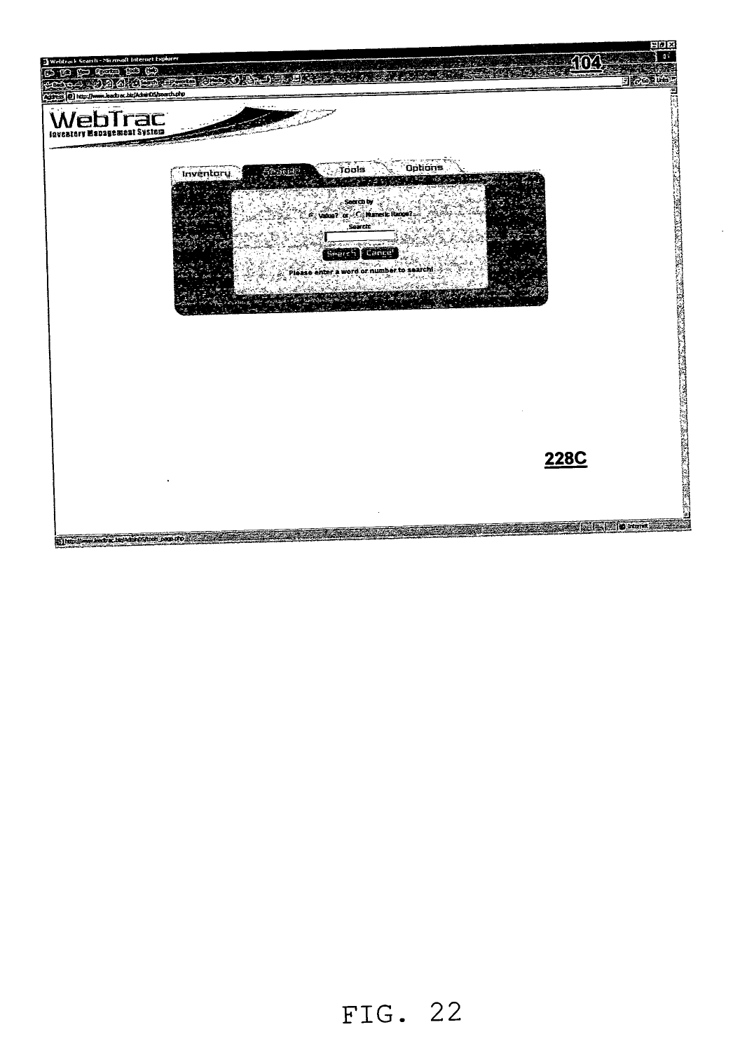

Once stored in an inventory database 38A on the server, inventory management and Internet marketing is supported by the WebTrac application 228C. Webtrac 228C allows an authenticated authorized user such as an inventory manager of the dealership to review, modify, and select inventory for promotion on an Internet marketing website, via a browser program 104 on a client computer 204. FIG. 21 depicts an example interface for an authorized user of WebTrac 228C. In FIG. 21 a columnar list 278 of all inventory is displayed, showing availability, stock number, year, vehicle description, milage, sales price, retail price, and the number of days the vehicle has been on the dealership lot. The information may be sorted as desired by clicking on a column header 280, such as to see inventory sorted by length of time on the lot, or by retail price, or by year, as examples. WebTrac 228C also provides controls 282 to allow an authorized user to select which columns are to be displayed, as depicted in FIG. 21. By selectively displaying information, a user may display a list 278 of available inventory to a potential customer without revealing information that is desirable to conceal from a customer, such as the sales price or number of days in inventory. Other features include the ability to search on a particular value such as a make or model year, or by a numeric range such as price or mileage, as depicted in FIG. 22.

Detailed information may be viewed on a particular vehicle by clicking the stock number from a list of vehicles. FIG. 23 illustrates information that may be viewed and edited for a particular vehicle, including VIN 284 and images 276-276C of the vehicle, as well as all other pertinent information.

In support of business operations, WebTrac 228C interfaces with MailMatrix 228A to allow an inventory manager to produce variable data documents 44 for reporting or management functions. By doing so, an inventory manager may specify, for example, reports featuring specific data on cars sold, or remaining in inventory, or documents profiling vehicles in inventory for the benefit of the sales force of the business. The WebTrac 228C application compiles the requested information, as well as the default document layout corresponding to the type of documents requested, and transfers this information to MailMatrix 228A for locating the desired data and generating data files 42 for the print server 10.

A second function of WebTrac 228C is to control the presentation of data on an Internet marketing website 100, such as depicted in FIG. 24. As shown in FIG. 23, the authorized user is presented with a number of controls for managing an Internet marketing website. The user may determine which vehicles will be listed on the marketing website using the “Post on Internet?” control 284. Additional controls 286 allow the user to select for each vehicle individually one or more marketing descriptions from a list of available description options. Selected marketing descriptions will automatically be displayed on the marketing website 100 with the vehicle description. Additionally, if an image or graphic is associated with a marketing description that is selected, the image or graphic is displayed with the vehicle description. For example, if “certified pre-owned vehicle” is selected for a particular vehicle that is posted to the marketing website, a graphic such as a certification seal would appear for display with the vehicle description when viewed by a visitor to the marketing website 100.

Other than the marketing descriptions available for selection, the user may choose to use edit field 288 to enter custom information for a particular vehicle, such as for a rare or otherwise exceptional vehicle. The custom information will then appear with the vehicle description on the marketing website.

A third function of WebTrac 228C is to receive and intelligently handle customer lead data from Internet sources. Internet customer lead information acquired by WebTrac 228C is stored in a customer lead database 38D on the system server 202 for immediate follow-up and later use in marketing efforts.

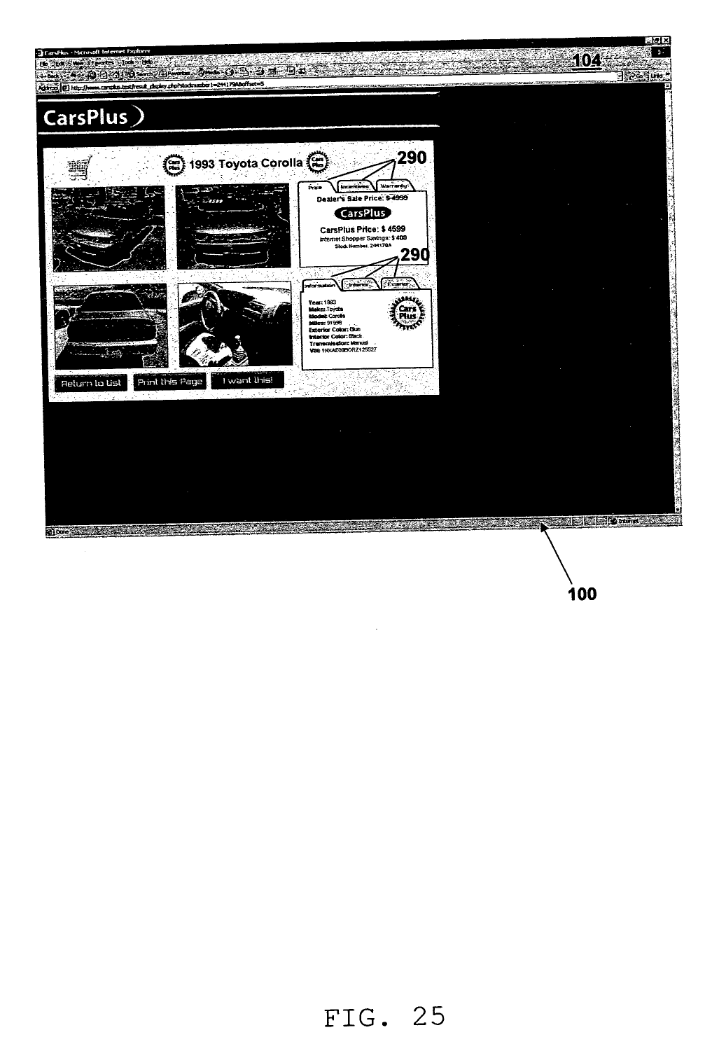

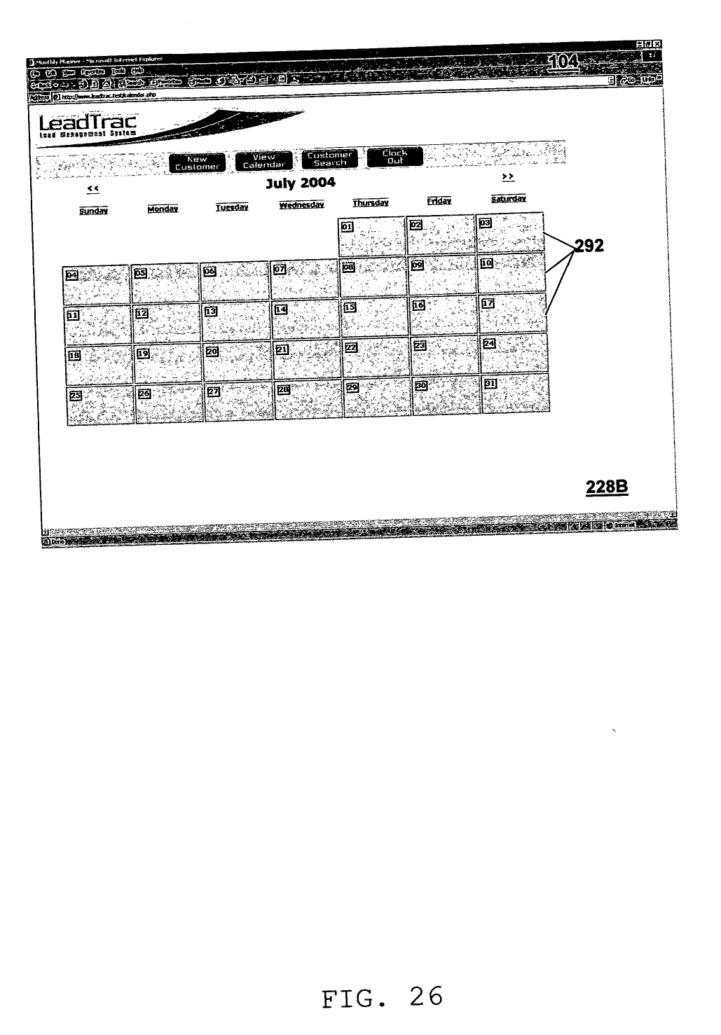

One source of Internet lead data comes from an Internet visitor's interaction with the marketing website 100, where all information may be tracked, including information directly provided by a visitor such as contact information accompanying a request for an appointment or further assistance. Non-directly provided information may also be acquired, such as any transactions a visitor may have with the marketing website 100 including searches preformed, vehicles examined or added to a shopping cart list, or vehicle information tab controls 290 that are activated (FIG. 25). Additional information may be obtained through the use of cookies, such as tracking prior visits to the dealership's marketing website, in addition to information from cookies placed by affiliated websites.

A second source of Internet lead data comes from third-party lead providers. Third-party lead providers provide websites for Internet visitors to search available vehicles from a large collection of dealerships. When a visitor to a third-party website selects a vehicle of particular interest, the third-party lead provider transmits the website visitor's supplied information to the dealership offering the visitor's selected vehicle, and bill the dealership for the lead information. Because visitors may visit several third-party lead provider's websites, WebTrac maintains a record of provided lead information to ensure that subsequent transmissions of the same customer lead information by other third-party lead providers do not result in additional billing to the dealership.

In further support of business operations, LeadTrac allows an authorized user to perform a large number of functions using the business data stored on the system server via a client web browser. A first function of LeadTrac is to provide sales support for each sales representative through scheduling functions, customer interaction retrieval and recording, and transaction support for a vehicle purchase. A second function of LeadTrac is to provide administrative support through reporting, roster management, and document production requests. LeadTrac also interfaces with MailMatrix for generation of variable data documents such as loan applications, customer data sheets, calendars and daily schedules, and reports of business activities.

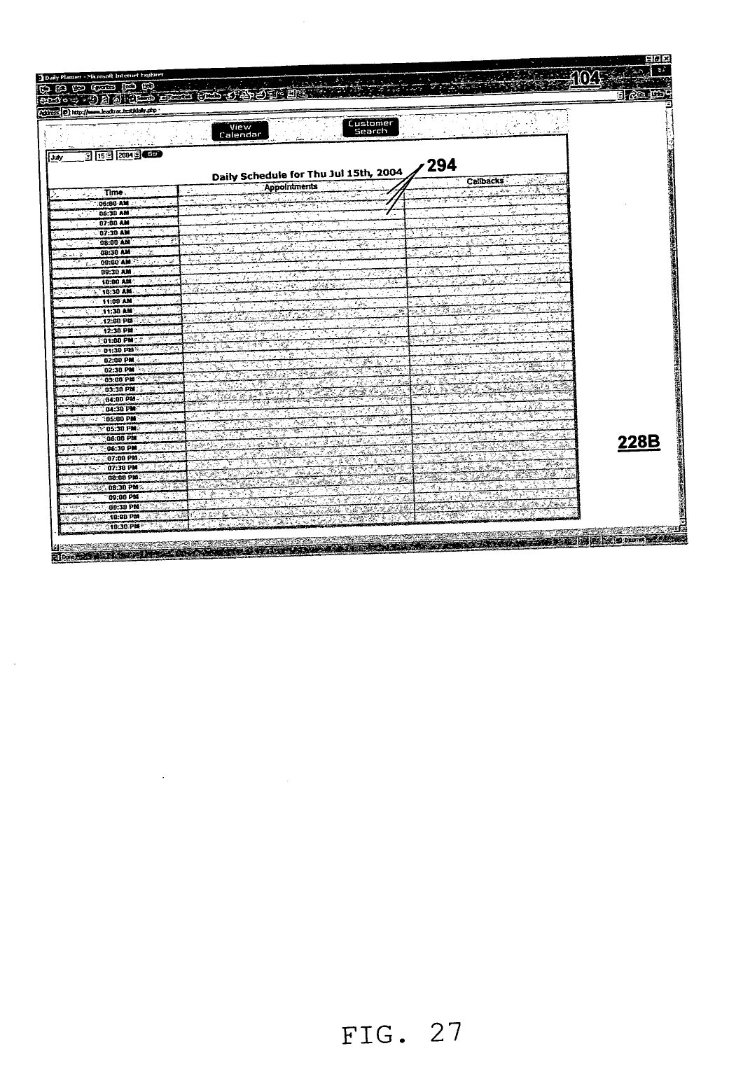

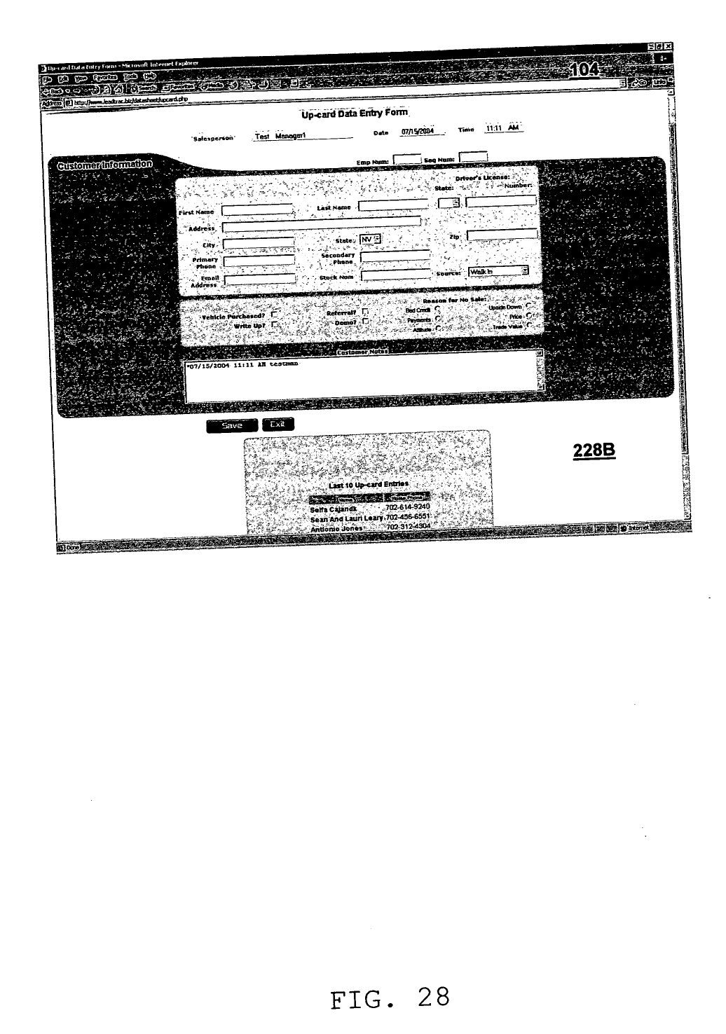

In support of sales representatives, scheduling functions are provided via an interface such as depicted in FIG. 26. A sales representative may select a particular calendar date to display a daily schedule (FIG. 27). Schedule entries may be generated automatically in response to a customer communication or may be manually entered by a sales representative.

Customer data acquired during a visit to the dealership may be entered by a sales representative. Frequently, a sales representative will carry a small sheet of paper called an upcard upon which the representative may write pertinent customer information such as name, phone number, vehicles shown or of interest, and the outcome of the customer visit. The data may be entered later using the LeadTrac upcard data entry interface shown in FIG. 28, and stored in a customer lead database on the system server.

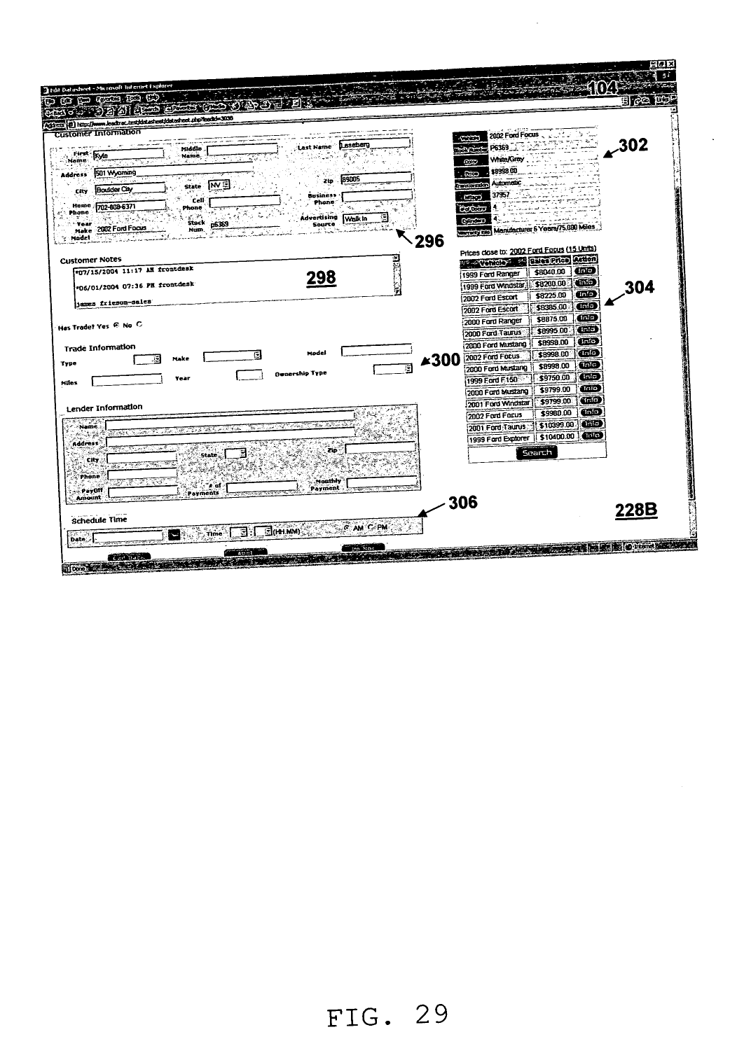

LeadTrac also provides an interface for viewing and editing a customer datasheet, comprising data stored in a customer lead database as shown in FIG. 29. Data represented in the datasheet interface includes personal information, special notations about the customer, trade-in information, the vehicle of interest to the customer, a list of other available vehicles similar to the vehicle of interest, and scheduling information.

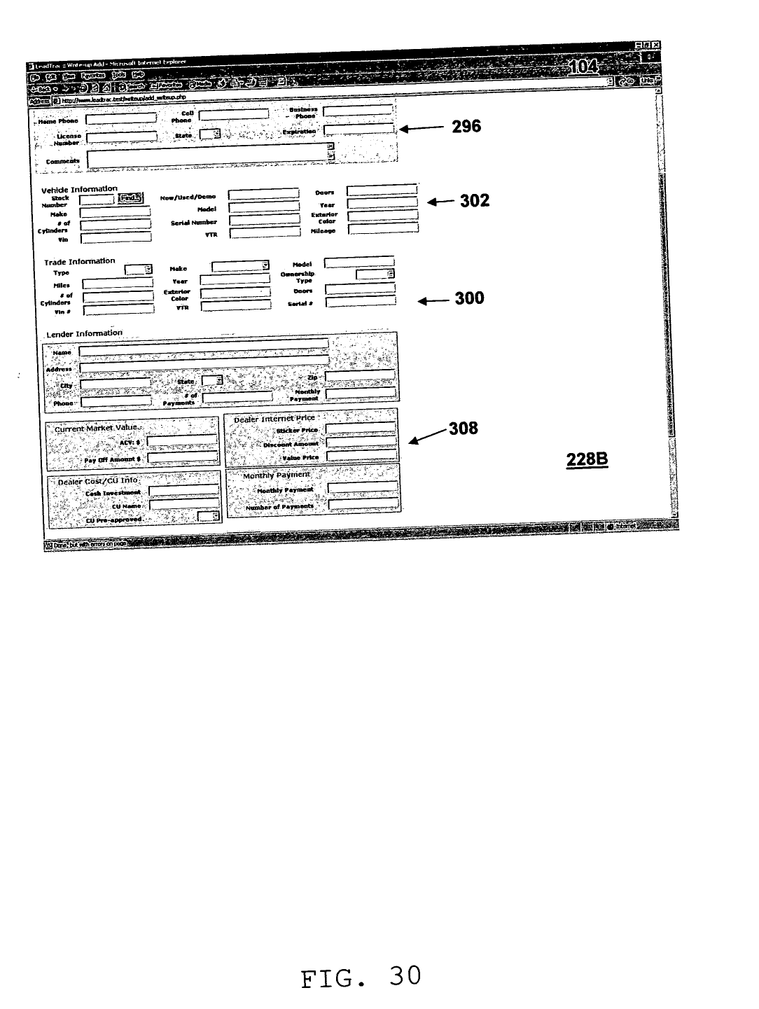

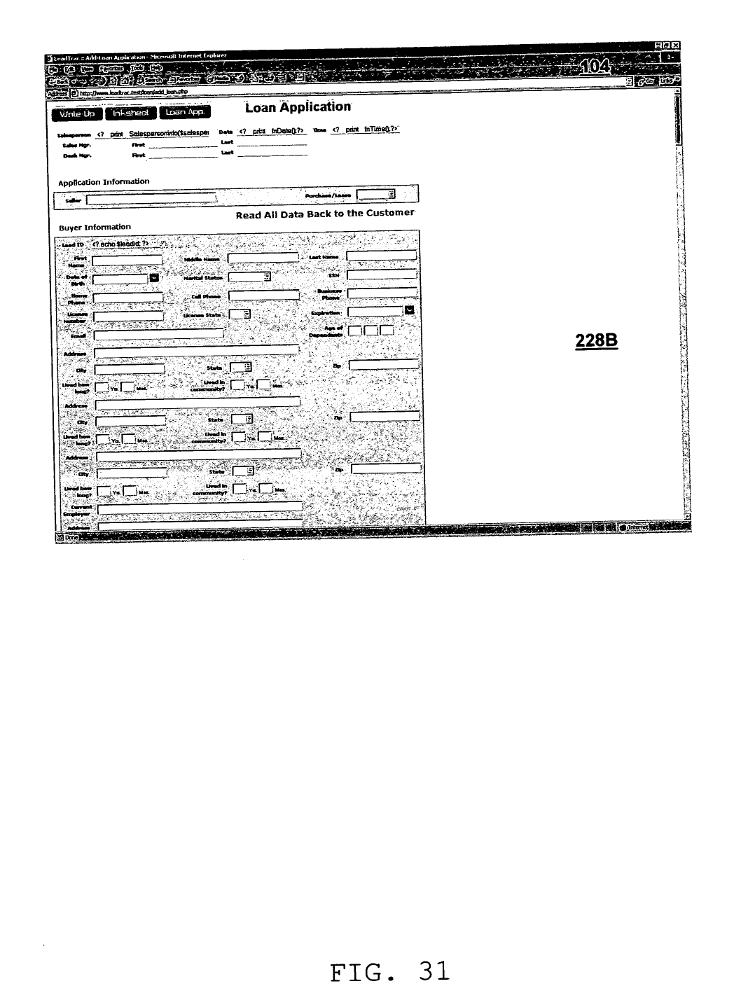

If a customer enters negotiation to purchase a vehicle, LeadTrac supports the sales process via the writeup interface shown in FIG. 30. The writeup interface allows presentation and editing of data relating to the customer personal information, the vehicle desired for purchase, the trade-in vehicle, and the “four square” data representing negotiated price, financing terms, trade-in value and pay-off amount, and dealer cost.

When agreement has been reached, LeadTrac accommodates electronic loan application for purchasers through the loan application interface partially shown in FIG. 31. Filling out a loan application is traditionally a tedious process, involving credit and banking accounts, co-buyer information, trade-in information, and so on. LeadTrac relieves much of the burden by prepopulating all data entry fields for which the dealership has available information from the customer database, such as may have been provided through upcard entry, input during a visit to the marketing website, or provided during previous visits or negotiations. Once entered, a sales representative may electronically submit the loan application to one or several lending institutions for quick approval or denial of financing.

Finally, if the dealership acquires images of a customer, such as a photograph taken with a newly-purchased vehicle, or with a vehicle of interest not yet purchased, LeadTrac allows a user to associate the digital image with the pertinent customer. FIG. 32 illustrates the interface used to create the association, which is stored in the customer database for later use in generating personalized variable-data documents.

Example of Systems in Support of Business Operations

One example depicting the seamless integration of several the described systems and methods of the present invention described in the previous example begins as a new vehicle arrives at the car dealership as inventory for sale. A dealership representative, equipped with a wireless tablet computer coupled to a digital camera and barcode reader or image scanner, photographs the car and, if provided, scans the barcode or the formatted vehicle information sheet; otherwise the representative manually enters vehicle data including VIN number.

The new vehicle data is wirelessly transmitted via the wireless interface to the system server. An application running on the system server formats the received information for transmission to CarFax via an Internet connection and for querying Karpower, a VIN database provided by Kelly Blue Book. The application collects the manufacturer information received from Kelly Blue Book and vehicle history information received from CarFax, again via the Internet. The collected vehicle information is stored in an inventory database, and the digital image files are stored in a file directory with file names encoded by stock number and image type.

Concurrently, a vehicle sales manager may decide to begin a promotion featuring the most recent vehicles acquired by the dealership. The manager directs a browser on a thin client computer system to the MailMatrix application residing on the system server. To generate personalized variable data documents for mailing, the sales manager navigates the available choices of document type, mailing recipients databases, and front and back document layouts that feature a “new inventory blow-out” theme. The sales manager sorts available inventory by length of time in inventory and selects the three most recent of each cars and trucks to be featured in the personalized variable data documents. The sales manager selects the variable data regions of the documents for showing images of the vehicles, with the constraint that the variable data regions be populated with truck images for male recipients and car images for female recipients.

Finally, the sales manager selects the dealership as the target destination for mailing recipients and enters a number of documents to be generated.

Having received all pertinent information, MailMatrix generates a promotional website featuring the “new inventory blow-out” theme and makes it available on the Internet via the web server program on the system server. Images and vehicle information shown on the promotional website are acquired from the inventory database and file directory on the system server.

To determine mailing recipients, MailMatrix performs database operations on the selected mailing recipients database to sort mailing address by proximity to the target destination. Recipients are selected until the specified number of documents to be generated is reached.

Image files for the selected vehicles and data files for generating the requested personalized variable data document mailers, including the URL of the promotional website, are then generated and sent to the print server for the variable data digital press. The data files also contain processing commands to query the gender of each recipient and provide either the car images or the truck images for each document. Once received by the print server, the variable data digital press produces the requested documents and they are mailed off.

A recipient of the mailers may be interested in one of the vehicles depicted on her mailer, and visits the promotional website via the Internet from her computer. She views the cars and trucks offered for sale and selects several using a shopping cart function. Viewing her selections, she compares the detailed information on each and determines one of particular interest. She then requests an appointment to view the selected vehicle by entering her contact information and operating a website control to submit the information.

When her appointment request is received, the scheduling database is queried to find an available sales representative at the location of the selected vehicle during the requested time. An email is generated confirming the appointment, giving the name of the sales representative she will be meeting, and directions to the dealership. The sales representative's schedule in the scheduling database is updated to reflect the new appointment, and all information captured during her interaction with the website is stored in a customer lead database.

Being a savvy purchaser, the potential purchaser visits several other automotive websites for comparison shopping prior to the appointment. Two of these websites record her visit and transmit her information to the dealership as a third-party customer lead provider. Upon receipt, WebTrac processes a database query identifying that the potential customer and her vehicle of interest has recently been added as a new customer lead. WebTrac identifies this duplication of lead data, logs the pertinent information for later report, and returns to each provider a lead rejection message.

On the morning of the appointment, the sales representative, using his thin client computer's browser, accesses LeadTrac to review his appointment schedule.

Having several appointments that day, he elects to print out available data on each prospective customer coming in. LeadTrac provides the identifying information to the MailMatrix application, which in turn retrieves from the customer lead database available information, generates data files for document generation, and transmits the data files to the variable data digital press system for production of the customer datasheets.

During the scheduled appointment with the prospective purchaser, the sales representative uses the LeadTrac transaction management functionality to facilitate the purchase of the desired vehicle. The sales representative pre-qualifies the potential customer by entering and electronically submit her identifying information to Experian, and receiving favorable results. Next the sales representative presents acceptable terms for the purchase of her desired vehicle and trade-in of her existing vehicle via the writeup interface. Finally, the sales representative uses the LeadTrac electronic loan application feature to generate an electronic loan application prepopulated with available information, with remaining information provided by the potential customer as needed.

Upon completion of the loan application, the sales representative instructs LeadTrac to electronically submit the information to several lending institutions having an existing relationship with the dealership. LeadTrac compiles the loan application information (storing it in the customer lead database for later use) and transmits the information via the Internet to the lending institutions, using an encryption algorithm to protect the sensitive data. One of the recipient lenders, after review, approves the application and transmits an acceptance to the system server. LeadTrac provides the sales representative with the loan acceptance information, which he relays to the customer.

Documents accompanying the purchase of a vehicle, such as the loan agreement, warranty information, etc., are prepared and provided to the purchaser. A representative accompanies the purchaser to the purchased vehicle and takes a digital image of her next to her new vehicle, and later of the newly-acquired trade-in vehicle, again entering the pertinent vehicle information including VIN. Additional information distribution, such as to motor vehicle regulatory bodies or insurance providers, may be supported by the LeadTrac or related systems.

Following the purchase, a personalized follow-up document is generated showing an image of the purchaser with her new vehicle and expressing thanks, in addition to explaining a referral program, and provided to the purchaser. The referral program provides entries into a drawing to win another new vehicle, based on the number of total referrals and successful purchases resulting therefrom. Periodic personalized documents are generated for each purchaser providing updated information on the status of the purchaser in the drawing, such as number of entries, and the date of the drawing.

In addition, the purchaser is provided with information about discounts through an affiliated network of local product and service providers, to help establish spending habits of the purchaser for items such as fuel, repair services, and entertainment. A coupon book is provided, as well as a magnetic stripe card for tracking purchases with the local providers and affirming the discounted prices. The purchase information, as well as credit history and other pertinent information collected, is later used to qualify and extend credit and financial services to vehicle purchasers, such as offering a credit card, at substantially reduced cost to the service provider.

It should be noted that the systems and methods of the present invention may be practiced by an entity other than a retail provider of goods and services. For example, an entity may practice the present invention as a service offering to a retailer, charging the retailer prices per printed piece competitive or discounted from that of a traditional print service, in addition to any other fee structure that may be desirable. For example, a monthly or annual fee for providing information services such as maintaining customer and inventory data and reporting capability, as well as additional payments corresponding to increased sales efficiency or profits as measured by agreed-upon metrics.

Significant benefits may also be achieved by an entity practicing methods and systems of the present invention in support of a retailer's operations by leveraging the existing retailer's infrastructure to accomplish additional product or service sales. As a particular example, an entity providing the methods and systems of the present invention to a car dealership may also engage in the marketing of the dealership's vehicles for sale via a marketing website or via niche marketing techniques such as providing direct mailing promotions to recent bankruptcy filers or members of a credit union, for example. Such Internet or niche marketing respondents may be scheduled to meet with the dealership's sales representatives, who, provided with all pertinent information on the customer, vehicle, and terms of sale, would actually complete the sale. In this way, the service provider may engage in and profit from the promotion and sale of vehicles while circumventing the expenses of maintaining an inventory, acquiring required licensing to conduct business, training a sales force, and other expenses and efforts that have already been satisfied by the dealership.

While the invention has been particularly shown and described with reference to the preferred embodiments thereof, it will be understood by those skilled in the art that the foregoing and other changes in form and details may be made therein without departing from the spirit and scope of the invention.

What is claimed is:

1. A method of using different and variable business data for various and separate business uses comprising the steps of:
providing at least one collection of business data for one business use of the various and separate business uses;
selecting at least one business item from said at least one collection of business data for the one business use; and
printing with a variable data digital press a plurality of documents wherein each of said documents includes information corresponding to said at least one business item selected for the one business use.

2. The method of claim 1 wherein at least one said collection of business data corresponds to inventory items, and further comprising the steps of:
collecting information corresponding to a new inventory item wherein said information comprising at least one digital image of said new inventory item;
adding said collected information to said collection of business data corresponding to inventory items; and
modifying said collection of business data corresponding to inventory items in response to a removal of an inventory item.

3. The method of claim 1 wherein a first said collection of business data corresponds to inventory items, a second said collection of business data corresponds to document layouts, a third said collection of business data corresponds to mailing recipients, said selecting comprises selecting at least one inventory item, at least one document layout, and at least one mailing recipient, said printing generates at least one personalized document for each said selected mail recipient, each said document having information corresponding to one of said selected mail recipients and at least one of said selected inventory items in conformity with said selected document layout.

4. The method of claim 3 wherein each said selected document layout having a theme, further comprising the step of automatically generating a promotional website having the theme of at least one said selected document layout wherein said promotional website providing information corresponding to said selected inventory items, each said printed document comprising an internet address corresponding to said promotional website, said theme comprising at least one of a color and a slogan.

5. The method of claim 1 wherein a first said collection of business data corresponds to customer leads and having values corresponding to a name, and address, and a phone number of each said customer lead, and further comprising the steps of:
adding values to said collection of business data corresponding to customer leads in response to a new customer lead; and
verifying values of said collection of business data corresponding to customer leads by performing at least one of an address verification against a current database of mailing addresses, a phone verification against a telephone directory, and a redundancy verification to prevent redundant customer leads, wherein said selecting comprises selecting at least one new customer lead, said printing results in a personalized follow-up document for mailing to each said selected new customer lead, each said personalized follow-up document having information corresponding to said selected new customer lead.

6. The method of claim 5 wherein a second said collection of business data corresponds to inventory items, said selecting further comprises selecting at least one inventory item for each said selected new customer lead by at least one of correlating said inventory item to preferences typical of a demographic category of said selected new customer lead, selecting inventory items determined to be of actual interest to said selected new customer lead, and selecting an inventory item that is a subject of a promotion, each said personalized follow-up document further having information corresponding to said at least one selected inventory item for said selected new customer lead.

7. The method of claim 1 wherein at least one said collection of business data comprises values corresponding to prior customers, said selecting is preformed by selecting at least one of said prior customers, said printing results in a personalized follow-up document for mailing to each of said selected prior customers wherein each said follow-up document having information corresponding to a different one of said selected prior customers.

8. The method of claim 7 further comprising the step of providing a referral incentive program for prior customers to benefit by providing referrals, wherein each said personalized follow-up document further having information about said referral incentive program.

9. The method of claim 1 further comprising the steps of:
providing at least one business, each said business having an inventory of items for sale and a sales staff, a first said collection of business data corresponds to said inventory items, a second said collection of business data corresponds to customer leads, a third collection of business data corresponds to mailing recipients, said selecting comprises selecting at least one mailing recipient, said printing generates at least one personalized document for each said selected mail recipient, each said personalized document having information corresponding to a different one of said selected mail recipients;
providing a website displaying information corresponding to a set of said inventory items and displaying contact information for a potential customer to initiate communication, said printing generates at least one personalized document for each said selected mail recipient, each said personalized document further having information corresponding to an address of said website;
acquiring new customer lead information in response to receiving a communication from said potential customer, said new customer lead information comprising at least one inventory item of interest to said potential customer;
selecting at least one of said at least one business having said at least inventory item of interest to said potential customer;
generating an appointment for said potential customer to visit at least one member of a sales staff of said selected business;
providing said selected business with said new customer lead information and said appointment information.

10. The method of claim 9 wherein said selecting of said mailing recipients is performed in conformity with at least one desired demographic characteristic, said set of inventory items displayed on said website is chosen to conform to at least one of a preference and a purchase capacity typical of said at least one demographic characteristic.

11. A computer network system for supporting various business operations, said computer network system comprising:
a variable data digital press system comprising a variable data digital press for generating variable data documents; and
at least one server coupled via said network system to said variable data digital press system, said at least one server comprising a server memory for storing both server program instructions and data and a server processor coupled to said server memory for executing said server program instructions, said server program instructions comprise:
program instructions for receiving information for generating variable data documents;
program instructions for locating data in said server memory in conformity with said information that is received;
program instructions for transforming said information that is received and said data that is located for use by said variable data digital press system; and
program instructions for transmitting said information that is transformed to said variable data digital press system for generation of said variable data documents.

12. The computer network system of claim 11 wherein said variable data digital press system further comprises a print server coupled to said variable data digital press and further coupled via said network system to said at least one server for controlling an operation of said variable data digital press in conformity with said information that is transmitted to said variable data digital press system.

13. The computer network system of claim 11 wherein said server memory stores data and images and wherein at least one said server having a wireless interface for receiving electronic information, and further comprising:
a digital camera for acquiring digital images; and
a portable data entry device for entering data, wherein at least one of said digital camera and said portable data entry device being coupled to said wireless interface for wirelessly transmitting to said server having a wireless interface at least one of said digital images and said data that is entered.

14. The computer network system of claim 11 wherein said server memory stores business data, said business data comprising both data corresponding to document recipients and data corresponding to document layouts, further comprising a client computer system coupled via said network system to said server, and wherein said server program instructions further comprise:
program instructions for transmitting to said client computer system information corresponding to said document recipients;
program instructions for receiving from said client computer system information corresponding to a selection of said document recipients;
program instructions for transmitting to said client computer system information corresponding to said document layouts, each said document layout having at least one variable data region;
program instructions for receiving from said client computer system information corresponding to a selection of said document layouts;
program instructions for transmitting to said client computer system information corresponding to business data; and
program instructions for receiving from said client computer system information corresponding to a selection of said business data for each said variable data region of said each said document layout that is selected, whereby a user of said client computer system determines at least one design of said variable data documents.

15. The computer network system of claim 14 wherein said client computer system further comprises a client computer memory for storing both client program instructions and data and a client computer processor coupled to said client computer memory for executing said program instructions of said client computer system, said program instructions of said client computer system comprise instructions for executing a browser program, said program instructions of said server comprise instructions for executing a web server program, so that said user determines said at least one design of said variable data documents via said browser program.

16. The computer network system of claim 14 wherein said coupling of said client computer system to said at least one server is wireless.

17. The computer network system of claim 14 wherein said business data further comprising data corresponding to inventory items and customers, and wherein said server program instructions further comprise:
receiving customer identification information from said client computer system;
receiving information form said client computer system identifying an inventory item selected for purchase by said customer; and
transmitting information corresponding to a document layout to said client computer system for supporting said purchase, wherein at least one variable data region of said document layout is prepopulated with information corresponding to at least one of said customer identification information and said inventory item.

18. The computer network system of claim 14 wherein said business data further comprising data corresponding to inventory items and data corresponding to customers, said at least one server being coupled via said network system to the Internet, said server program instructions further comprise:
program instructions for receiving customer identification information from said client computer system;
program instructions for transmitting said customer identification information to an Internet information provider for querying at least one of customer credit information and financing approval information;
program instructions for receiving a result of said query; and
program instructions for transmitting a result of said query to said client computer system.

19. The computer network system of claim 14 wherein said business data further comprising data corresponding to inventory items, said at least one server being coupled via said network system to the Internet, said server program instructions further comprise:
program instructions for hosting an Internet marketing website, said marketing website comprising both information corresponding to said inventory items and controls for a marketing website visitor to initiate a query; and
program instructions for providing information to said marketing website visitor in response to said query.

20. A computer network system for supporting various business operations, said computer network system comprising:
a variable data digital press for generating variable data documents;
a print server coupled via said network system to said variable data digital press for controlling an operation of said variable data digital press;
a client computer system comprising:
a client computer memory for storing both data and client computer program instructions;
a client computer processor coupled to said client computer memory for executing said client program instructions;
a graphical display device coupled to said client computer processor for displaying a graphical user interface; and
an input device coupled to said client computer processor for providing user input,
said client computer program instructions comprise program instructions for a browser program executing within said client computer system; and
a server coupled via said network system to said print server and further coupled via said network system to said client computer system, said server comprising a server memory for storing both server program instructions and data and a server processor coupled to said server memory for executing said server program instructions, wherein said server memory comprises inventory data, document layout data, and at least one database of mailing recipients, said server program instructions comprise:
program instructions for a web server program executing within said server for transmitting and receiving data from said client browser program;
program instructions for transmitting information to said client browser program corresponding to said document layout data;
program instructions for receiving information corresponding to a selection of at least one document layout;
program instructions for transmitting information to said client browser program corresponding to said mailing recipient databases in conformity with said at least one document layout that is selected;
program instructions for receiving information corresponding to a selection of at least one said database of mailing recipients;
program instructions for receiving information corresponding to a number of variable data documents to be generated;
program instructions for receiving information corresponding to a target mailing destination;
program instructions for transmitting information to said client browser program for graphically depicting said at least one document layout that is selected, said at least one document layout that is selected having at least one variable data region;
program instructions for transmitting information to said client browser program for populating said at least one variable data region, said information comprising at least one of mailing recipient data fields, inventory description data, and inventory images;
program instructions for receiving information corresponding to a selection of information for populating said variable data regions;
program instructions for generating at least one data file, said at least one data file comprising data corresponding to said at least one document layout that is selected and data corresponding to said selection of information for populating said variable data regions, wherein mailing recipients are selected from said selection of at least one mailing recipient database in conformity with a proximity to said target mailing destination and said number of variable data documents to be generated, said at least one data file further comprising data corresponding to said mailing recipients that are selected, said at least one data file having a format readable by said print server; and
program instructions for transmitting to said print server said at least one data file that is generated, for production of variable data documents by said variable data digital press.
